(19) United States
(12) Patent Application Publication
(10) Pub. No.: US 2026/0012323 A1
(43) Pub. Date: Jan. 8, 2026

(54) METHOD AND APPARATUS FOR MEASURING CROSS LINK INTERFERENCE IN WIRELESS COMMUNICATION SYSTEM

(71) Applicant: SAMSUNG ELECTRONICS CO., LTD., Suwon-si (KR)

(72) Inventors: Jeongseok YU, Suwon-si (KR); Seungri JIN, Suwon-si (KR); Sangbum KIM, Suwon-si (KR); Beomsik BAE, Suwon-si (KR)

(21) Appl. No.: 19/261,848

(22) Filed: Jul. 7, 2025

(30) Foreign Application Priority Data
Jul. 8, 2024 (KR) 10-2024-0089824

(51) Int. Cl. H04L 5/14; H04B 7/06; H04B 17/318; H04W 24/10

(52) U.S. Cl. CPC H04L 5/14; H04B 7/0626; H04B 17/328; H04W 24/10

(57) ABSTRACT

The disclosure relates to a 5G or 6G communication system for supporting a higher data transmission rate. According to various embodiments of the disclosure, a method for processing a control signal in a wireless communication system may include receiving a first control signal transmitted from a base station, processing the received first control signal, and transmitting, to the base station, a second control signal generated based on the processing.

### CROSS-REFERENCE TO RELATED APPLICATION

This application is based on and claims priority under 35 U.S.C. § 119 to Korean Patent Application No. 10-2024-0089824, filed on Jul. 8, 2024, in the Korean Intellectual Property Office, the disclosure of which is herein incorporated by reference in its entirety.

### BACKGROUND

### 1. Field

The disclosure generally relates to a wireless communication system and, more specifically, to a method and an apparatus for measuring and managing cross link interference in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Based on the discussion above, an aspect of the disclosure is to provide a method and an apparatus for measuring and managing cross link interference in a wireless communication system, thereby providing a method and an apparatus for more accurately identifying and mitigating interference due to a cross link.

The technical subjects pursued in the disclosure may not be limited to the above-mentioned technical subjects, and other technical subjects which are not mentioned herein may be clearly understood from the following descriptions by those skilled in the art to which the disclosure pertains.

According to various embodiments of the disclosure, a method for processing a control signal in a wireless communication system may include receiving a first control signal transmitted from a base station, processing the received first control signal, and transmitting, to the base station, a second control signal generated based on the processing.

An embodiment of the disclosure provides an apparatus and a method in which each cell may effectively measure and mitigate an interference signal from another cell.

According to an embodiment of the disclosure, an apparatus and a method capable of effectively providing services in a wireless communication system can be provided.

Advantageous effects obtainable from the disclosure may not be limited to the above-mentioned effects, and other effects which are not mentioned herein may be clearly understood from the following description by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system according to an embodiment of the disclosure;

FIG. 2 illustrates a user plane radio protocol structure of a wireless communication system according to an embodiment of the disclosure;

FIG. 3 illustrate a control plane radio protocol structure according to an embodiment of the disclosure;

FIGS. 4A to 4D illustrate various examples of time division duplex (TDD) and subband full duplex (SBFD) communication methods according to an embodiment of the disclosure;

FIGS. 5A and 5B illustrate an example of sharing pattern information of communication methods between a distributed unit (DU) and a central unit (CU) within a base station and a signal flow according to an embodiment of the disclosure;

FIGS. 6A and 6B illustrate an example of sharing pattern information of communication methods between CUs of different base stations and a signal flow according to an embodiment of the disclosure;

FIG. 7 illustrates a signal flow for measuring and reporting CLI by using an L3 measurement reporting framework according to an embodiment of the disclosure;

FIG. 8 illustrates a signal flow of measuring and reporting CLI by using an L1 measurement report framework according to an embodiment of the disclosure;

FIGS. 9A and 9B illustrate an example of a relationship between a resource for measuring CLI and a resource used for a downlink (DL) or uplink (UL) according to an embodiment of the disclosure;

FIG. 10 illustrates a signal flow for predicting a CLI victim UE according to an embodiment of the disclosure;

FIG. 11 illustrates a signal flow for selecting a beam-based aggressor UE and measuring CLI according to an embodiment of the disclosure;

FIG. 12 illustrates a signal flow for mitigating CLI based on CLI measurement reporting according to an embodiment of the disclosure;

FIG. 13 illustrates a signal flow for dynamically indicating a CLI measurement resource from a base station to a UE according to an embodiment of the disclosure;

FIG. 14 illustrates a structure of a base station according to an embodiment of the disclosure; and

FIG. 15 illustrates a structure of a UE according to an embodiment of the disclosure.

### DETAILED DESCRIPTION

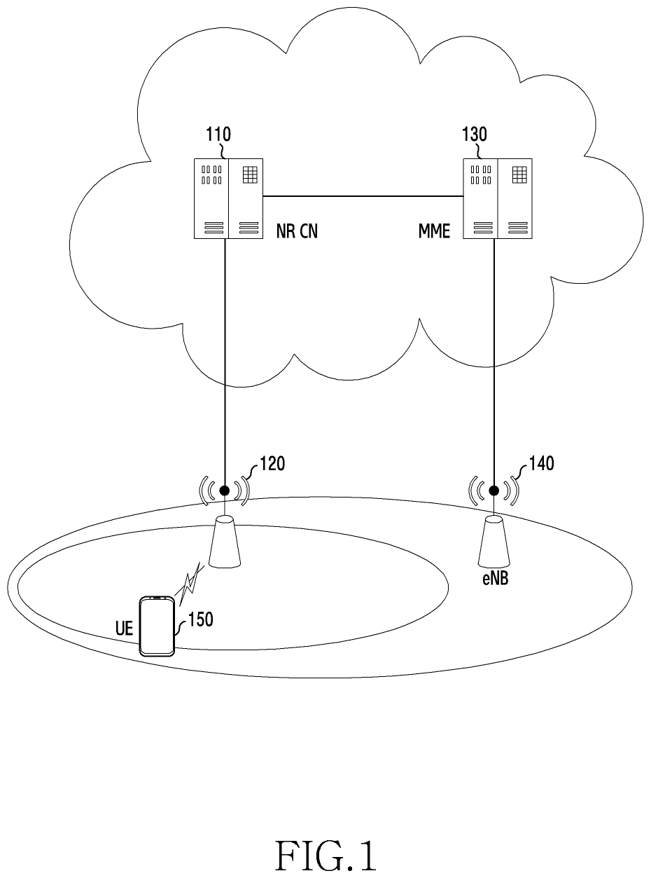

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The following detailed description of embodiments of the disclosure is mainly directed to new RAN (NR) as a radio access network and packet core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

5G mobile communication technologies define broad frequency bands to enable high transmission rates and new services, and can be implemented not only in “Sub 6 GHz” bands such as 3.5 GHz, but also in ultrahigh frequency (“above 6 GHz”) bands referred to as mmWave such as 28 GHz and 39 GHz. In addition, it has been considered to implement 6G mobile communication technologies (referred to as beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced mobile broadband (eMBB), ultra reliable & low latency communications (URLLC), and massive machine-type communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for securing coverage in terahertz bands of 6G mobile communication technologies, full dimensional MIMO (FD-MIMO), multi-antenna transmission technologies such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

FIG. 1 illustrates a structure of a wireless communication system according to an embodiment of the disclosure.

Referring to FIG. 1, a radio access network of a wireless communication system (hereinafter NR or 5G) may include a next-generation base station (new radio node B) (hereinafter NR gNB, gNB, or NR base station) 120, and a new radio core network (NR CN) 110. A user terminal (e.g., new radio user equipment) (hereinafter NR UE or NR terminal) 150 may access an external network via the NR gNB 120 and the NR CN 110.

The NR gNB 120 may be connected to the NR UE 150 through a radio channel and provide outstanding services as compared to the eNB 140. In the next-generation mobile communication system, since all user traffic is serviced through a shared channel, a device that collects state information, such as buffer statuses, available transmit power states, and channel states of UEs, and performs scheduling accordingly is required, and the NR gNB 120 may serve as the device. In general, one NR gNB 120 may control multiple cells. In order to implement ultrahigh-speed data transfer beyond LTE, a wider bandwidth than the maximum bandwidth of LTE may be used, an orthogonal frequency division multiplexing (hereinafter referred to as OFDM) may be employed as a radio access technology, and a beamforming technology may be additionally integrated therewith. Furthermore, an adaptive modulation and coding (AMC) scheme for determining a modulation scheme and a channel coding rate according to a channel state of a UE may be employed. The NR CN 110 may perform functions such as mobility support and QoS configuration. The NR CN 110 is a device responsible for various control functions as well as a mobility management function for a UE, and may be connected to multiple base stations. In addition, the next-generation mobile communication system may interwork with the existing LTE system, and the NR CN 110 may be connected to an MME 130 via a network interface. The MME 130 may be connected to the eNB 140.

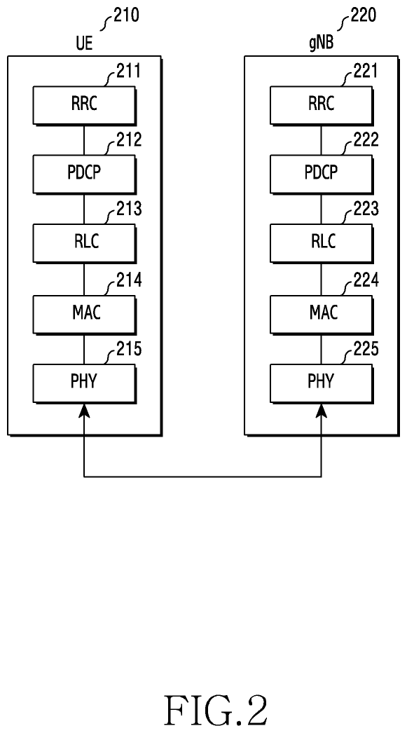

FIG. 2 illustrates a user plane radio protocol structure in a wireless communication system according to an embodiment of the disclosure.

Referring to FIG. 2, in a UE 210, a user plane radio protocol of a next-generation mobile communication system may include an SDAP 211, a PDCP 212, an RLC 213, an MAC 214, and/or a PHY 215. In a gNB 220, the user plane radio protocol of the next-generation mobile communication system may include an SDAP 221, a PDCP 222, an RLC 223, an MAC 224, and/or a PHY 225. In the disclosure, the expression “may include” may be replaced with the expression “may consist of.” For example, in a UE 210, a user plane radio protocol of a next-generation mobile communication system may consist of an SDAP 211, a PDCP 212, an RLC 213, an MAC 214, and/or a PHY 215.

According to an embodiment, the functions of the SDAP 211 or 221 may include at least some of functions below. However, the disclosure is not limited thereto:
Mapping between a quality of service (QOS) flow and a data radio bearer;
Marking QoS flow ID (QFI) in both DL and UL packets;

According to an embodiment, the functions of the PDCP 212 or 222 may include at least some of functions below. However, the disclosure is not limited thereto;
Transfer of data (user plane or control plane);
Maintenance of PDCP sequence numbers (SNs);
Header compression and decompression using ROHC protocol;
Header compression and decompression using EHC protocol;
Compression and decompression of uplink PDCP SDUs: DEFLATE based UDC only;
Ciphering and deciphering;
Integrity protection and integrity verification);
Timer based SDU discard;
For split bearers, routing;
Duplication;
Reordering and in-order delivery;
Out-of-order delivery; and/or
Duplicate discarding.

According to an embodiment, the functions of the RLC 213 or 223 may include some of functions below. However, the disclosure is not limited thereto:
Transfer of upper layer PDUs;
Sequence numbering independent of the one in PDCP (UM and AM);
Error correction through ARQ (AM only);
Segmentation (AM and UM) and re-segmentation (AM only) of RLC SDUs;
Reassembly of SDU (AM and UM);
Duplicate detection (AM only);
RLC SDU discard (AM and UM);
RLC re-establishment; and/or
Protocol error detection (AM only).

According to an embodiment, the functions of the RLC 213 or 223 may include at least some of functions below. However, the disclosure is not limited thereto:
Mapping between logical channels and transport channels;
Multiplexing of MAC SDUs from one or different logical channels onto transport blocks (TBs) to be delivered to physical layer on transport channels;
Demultiplexing of MAC SDUs to one or different logical channels from transport blocks (TBs) delivered from physical layer on transport channels;
Scheduling information reporting;
Error correction through HARQ;
Logical channel prioritization; and/or
Priority handling between overlapping resources of one UE.

According to an embodiment, the PHY layer 215 or 225 may perform channel coding and modulation of upper layer data to generate OFDM symbols and may convert the OFDM symbols into an RF signal and then transmit the same through an antenna, In addition, the PHY layer 215 or 225 may perform demodulation and channel decoding of the received OFDM symbols and then transfer the OFDM symbols to an upper layer.

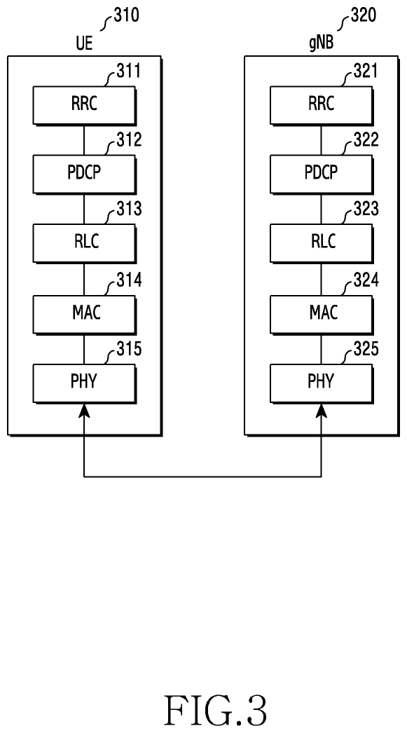

FIG. 3 illustrates a control plane radio protocol structure according to an embodiment of the disclosure.

Referring to FIG. 3, a control plane radio protocol of a next-generation mobile communication may include RRC 311, PDCP 312, RLC 313, MAC 314, and/or PHY 315 in a UE 310. In a base station 320, RRC 321, PDCP 322, RLC 323, MAC 324, and/or PHY 325 may be included.

According to an embodiment, functions of the RRC 311 or 321 may include at least some of the following functions:
Broadcast of system information (Broadcast of System Information related to AS and NAS);
Paging (Paging initiated by 5GC or NG-RAN);
Establishment and maintenance of an RRC connection between the UE and NG-RAN and addition, modification, and release of carrier aggregation and dual connectivity between NRs or NR and LTE (Establishment, maintenance and release of an RRC connection between the UE and NG-RAN including: addition, modification and release of carrier aggregation; Addition, modification and release of Dual Connectivity in NR or between E-UTRA and NR.);
Security functions including key management;
Establishment, configuration, maintenance, and release of signaling radio bearers and data radio bearers (Establishment, configuration, maintenance and release of Signaling Radio Bearers (SRBs) and Data Radio Bearers (DRBs));
UE mobility support (mobility functions including: handover and context transfer; UE cell selection and reselection and control of cell selection and reselection; inter-RAT mobility.);
QoS management functions;
UE measurement reporting and control of the reporting;
Detection of and recovery from radio link failure; and/or
NAS message transfer (NAS message transfer to/from NAS from/to UE).

According to various embodiment, main functions of the PDCP 312 or 322, the RLC 313 or 323, the MAC 314 or 324, and/or the PHY 315 or 325 may follow the example shown in FIG. 2.

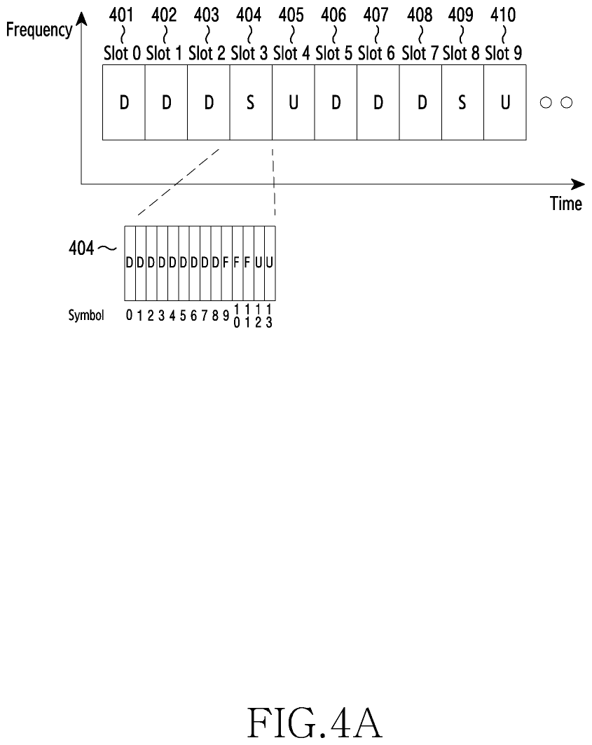

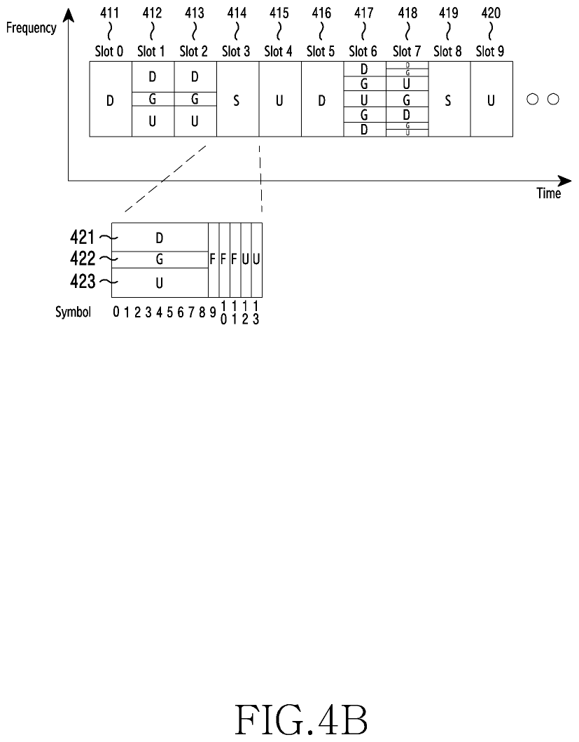

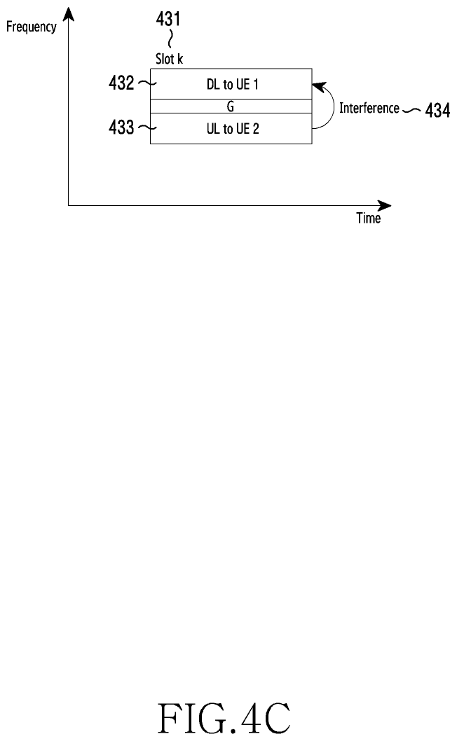

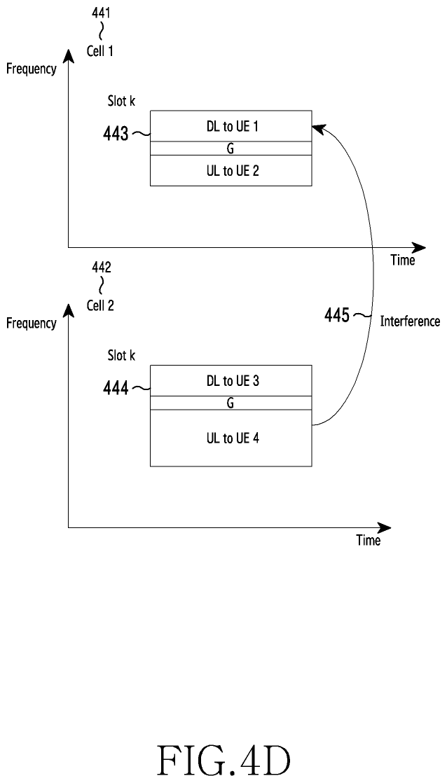

FIGS. 4A and 4B illustrate various examples of time division duplex (TDD) and subband full duplex (SBFD) communication methods according to an embodiment of the disclosure.

Referring to FIG. 4A, a TDD method for transmitting or receiving a DL 401, 402, 403, 406, 407, or 408 or a UL 405 or 410 may be used for a bandwidth part used by a base station corresponding to all symbols included in a specific slot in the next-generation mobile communication system. In addition, there may be at least one symbol used as a DL, at least one symbol used as a UL among the remaining symbols, and a special slot 404 or 409 including a flexible symbol among a portion of the remaining symbols, which may be configured to be used as a DL or UL to transmit or receive according to an indication from the base station. It may be also possible that there is a flexible slot where all symbols in a slot are flexible.

According to an embodiment, the TDD method may have the disadvantage that a DL and a UL may not be transmitted or received simultaneously in the same slot or symbol, resulting in a long interval between DL or UL transmissions. For example, it may take one slot and five symbols of time from receiving the last DL in a special slot 404 (e.g., symbol 8) to symbol 0 in slot 5 406 receiving the next DL. In addition, it may take three slots and eleven symbols of time from transmitting the last UL in slot 4 405 to symbol 12 in slot 8 409 transmitting the next UL.

To address the aforementioned disadvantage, a subband full duplex (SBFD) method which may concurrently configure a subband for transmitting a DL and a subband for transmitting a UL at a specific time point (e.g., a specific slot or symbol) may be employed as shown in FIG. 4B.

Referring to FIG. 4B, the SBFD may include a DL subband 421, a UL subband 423, and a guard band 422, and the guard band 422 may be disposed to reduce interference between the DL subband 421 and the UL subband 423. In case of configuring the number of subbands to a minimum, there may be one DL subband, one UL subband, and one guard band each. Furthermore, it is also possible to configure a subband using more than two of the same subband, such as slot 6 417 or slot 7 418. This subband configuration corresponds to the transmit and receive perspective of the base station, and one UE may be configured to perform only DL reception using the DL subband, or only UL transmission using the UL subband.

Referring to FIG. 4C, in case that the UE performs transmission 433 in the UL subband, there may be intra-cell UE-to-UE CLI that causes interference 434 to the UE performing reception 432 using the DL subband from a neighboring frequency of the same slot 431 or symbol.

Referring to FIG. 4D, in case that different cells 441 and 442 have different subband configurations for the same frequency or neighboring frequencies at the same time, there may be inter-cell UE-to-UE CLI that causes interference 445 from the transmission 444 of the UL subband to the DL subband 443. The inter-cell UE-to-UE CLI may be generated by different TDD UL/DL configurations in conventional TDD communication.

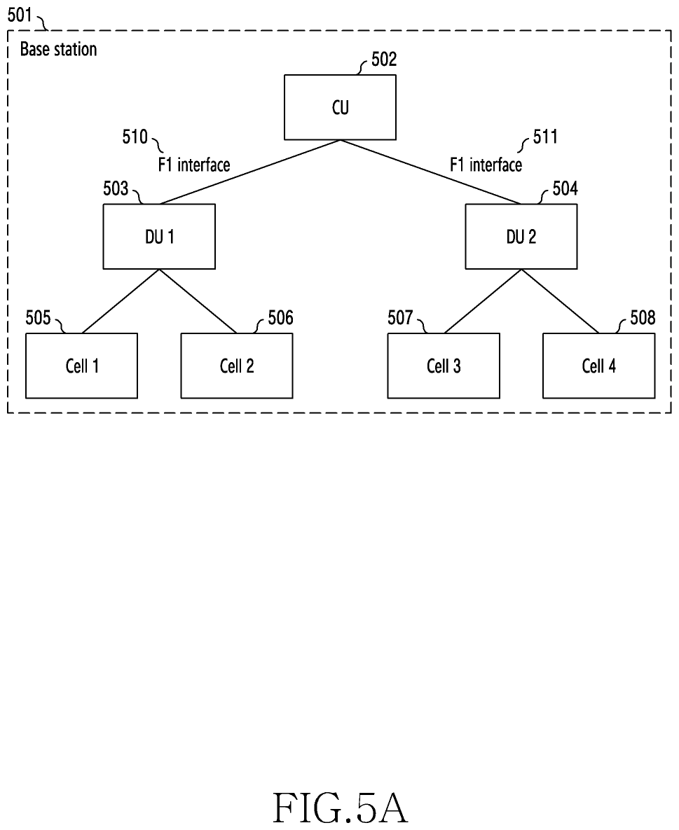

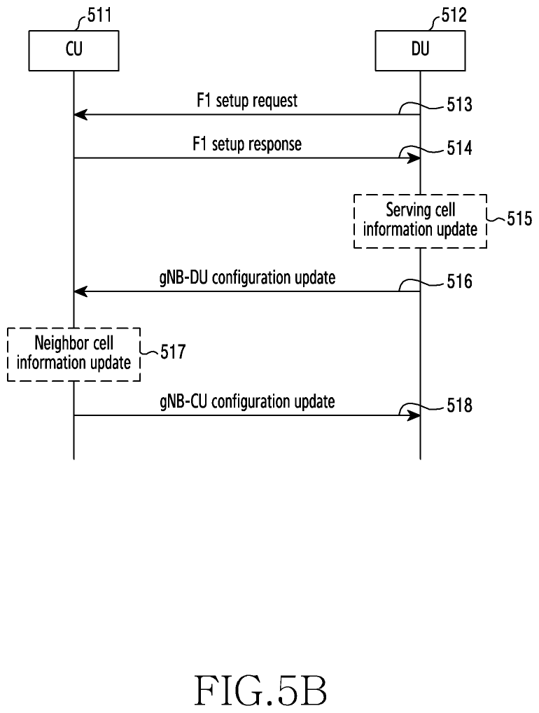

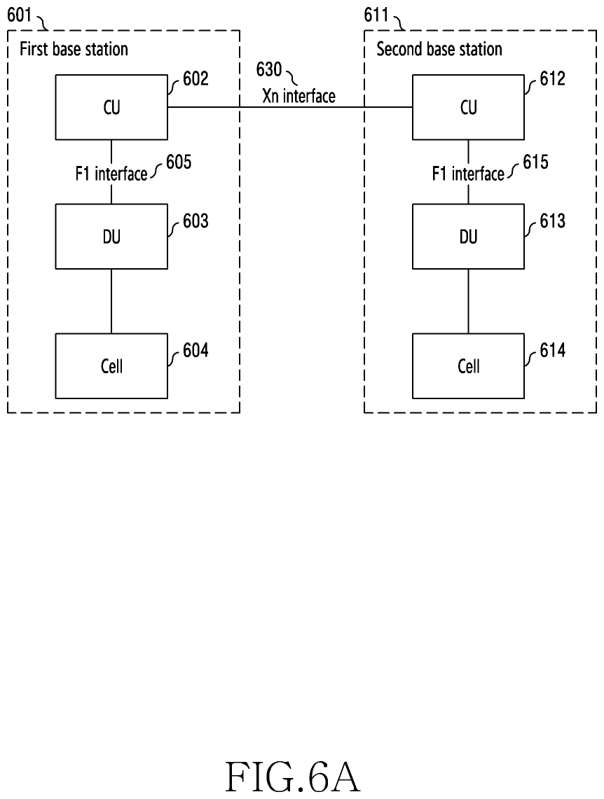

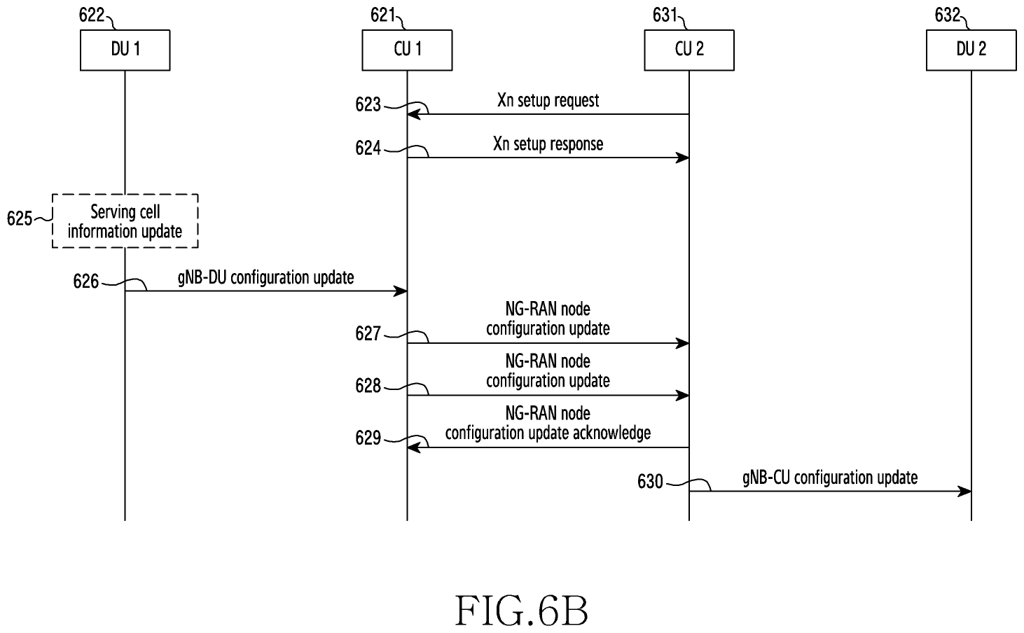

According to an embodiment, in order to predict Inter-cell CLI, the DU and the CU in the same base station or the CU and the CU in different base stations may share TDD pattern information and this will be described below with reference to FIGS. 5A to 6B.

FIGS. 5A and 5B illustrate an example of sharing pattern information of communication methods between a distributed unit (DU) and a central unit (CU) within a base station and a signal flow according to an embodiment of the disclosure. More specifically, FIGS. 5A and 5B illustrate a method in which a DU and a CU within one base station share TDD pattern information or SBFD pattern information to predict inter-cell CLI.

Referring to FIG. 5A, the base station 501 and the CU 502 may service at least one DU 503 or 504. Each DU 503 or 504 may service at least one cell 505, 506, 507, or 508. Each cell 505, 506, 507, or 508 may configure different TDD or SBFD patterns depending on a purpose of service. The TDD pattern or SBFD pattern of cells in service within one DU may be directly configured to the DU or each cell, and this may be configured through an operation and management (OAM) interface. However, this is merely an example and the disclosure is not limited thereto.

According to an embodiment, the DU 503 or 504 may establish an F1AP connection 510 or 511 with the CU 502 to exchange information through an F1 interface.

According to various embodiments, FIG. 5B illustrates a signal flow for F1AP message transmission between one CU 511 and one DU 512.

Referring to FIG. 5B, in step 513, the DU 512 may transmit an F1 SETUP REQUEST message for the F1AP connection to the CU 511.

In step 514, the CU 511 having received F1 SETUP REQUEST may respond with F1 SETUP RESPONSE.

In step 515, the DU 512 may update information of a cell serviced by the DU.

In step 516, in case that the information of the cell is updated, the DU 512 may transmit a GNB-DU CONFIGURATION UPDATE message through the F1AP to inform the CU of the change. According to an embodiment, in case that the information of a cell being serviced has been updated, the DU 512 may recognize the update through the OAM interface.

In step 517, the CU 511 may update information of a neighbor cell.

In step 518, in case that the information of the neighbor cell is updated, the CU 511 may transmit a GNB-CU CONFIGURATION UPDATE message through the F1AP to inform the DU 512 of the change. According to an embodiment, in case that the information of the neighbor cell is updated, the CU 511 may recognize the update through the XnAP interface.

According to various embodiments, the update of the neighbor cell will be described in detail with reference to FIGS. 6A and 6B.

According to an embodiment, an F1AP message (e.g., F1 SETUP REQUEST, or GNB-DU CONFIGURATION UPDATE) transmitted by the DU 512 may include at least one of Served Cell Information or Neighbor Cell Information. According to an embodiment, Served Cell Information may include TDD information, SBFD information of the cell being serviced by the DU 512 transmitting the F1AP message, and such information may include information about the pattern and periodicity of a UL and DL slot or symbol.

According to an embodiment, the F1AP message (e.g., GNB-CU CONFIGURATION UPDATE) transmitted by the CU 511 may include TDD information of a neighboring cell, SBFD information of a neighboring cell, and such information may include information about the pattern and periodicity of a UL and DL slot or symbol.

According to an embodiment, information for a pattern and periodicity of a UL and DL slot or a symbol indicating the TDD information may be described as shown as [Table 1] or [Table 2].

### 9.2.2.40 Intended TDD DL-UL Configuration NR

This IE contains the subcarrier spacing, cyclic prefix and TDD DL-UL slot configuration of an NR cell that a neighbor NG-RAN node needs to take into account for cross-link interference mitigation, and/or for NR-DC power coordination, when operating its own cells.

TABLE 1

| | | | IE Type and | Semantics |
|---|---|---|---|---|
| IE/Group Name | Presence | Range | Reference | Description |
| NR SCS | M | | ENUMERATED | The values |
| | | | (scs15, scs30, | scs15, scs30, |
| | | | scs60, scs120, . . .) | scs60 and |
| | | | | scs120 |
| | | | | corresponds to |
| | | | | the sub carrier |
| | | | | spacing in TS |
| | | | | 38.104 [24]. |
| NR Cyclic Prefix | M | | ENUMERATED | The type of |
| | | | (Normal, | cyclic prefix, |
| | | | Extended, . . .) | which |
| | | | | determines the |
| | | | | number of |
| | | | | symbols in a |
| | | | | slot. |
| NR DL-UL | M | | ENUMERATED | The periodicity |
| Transmission | | | (ms0p5, ms0p625, | is expressed in |
| Periodicity | | | ms1, ms1p25, | the format |
| | | | ms2, ms2p5, ms3, | msXpYZ, and |
| | | | ms4, ms5, ms10, | equals X.YZ |
| | | | ms20, ms40, | milliseconds. |
| | | | ms60, ms80, | |
| | | | ms100, ms120, | |
| | | | ms140, ms160, . . .) | |
| Slot Configuration | | 1 | | |
| List | | | | |
| >Slot | | 1 . . . | | |
| Configuration List | | <maxnoofslots> | | |
| Item | | | | |
| >>Slot Index | | | INTEGER (0 . . . 5119) | |
| >>CHOICE | M | | | |
| Symbol Allocation | | | | |
| in Slot | | | | |
| >>>All DL | | | | |
| >>>All UL | | | | |
| >>>Both DL and | | | | |
| UL | | | | |
| >>>>Number | M | | INTEGER (0 . . . 13) | Number of |
| of DL Symbols | | | | consecutive DL |
| | | | | symbols at the |
| | | | | beginning of the |
| | | | | slot identified by |
| | | | | Slot Index. If |
| | | | | extended cyclic |
| | | | | prefix is used, |
| | | | | the maximum |
| | | | | value is 11. |
| >>>>Number | M | | INTEGER (0 . . . 13) | Number of |
| of UL Symbols | | | | consecutive UL |
| | | | | symbols in the |
| | | | | end of the slot |
| | | | | identified by |
| | | | | Slot Index. If |
| | | | | extended cyclic |
| | | | | prefix is used, |
| | | | | the maximum |
| | | | | value is 11. |

TABLE 2

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |
| pattern2 | TDD-UL-DL-Pattern |

OPTIONAL, -- Need R
...
}

| | |
|---|---|
| TDD-UL-DL-Pattern ::= | SEQUENCE { |
| dl-UL-TransmissionPeriodicity | ENUMERATED {ms0p5, ms0p625, ms1, ms1p25, ms2, ms2p5, |
| ms5, ms10}, | |
| nrofDownlinkSlots | INTEGER (0..maxNrofSlots), |
| nrofDownlinkSymbols | INTEGER (0..maxNrofSymbols-1), |
| nrofUplinkSlots | INTEGER (0..maxNrofSlots), |
| nrofUplinkSymbols | INTEGER (0..maxNrofSymbols-1), |

```
  ...,
  [[
```

| | | |
|---|---|---|
| dl-UL-TransmissionPeriodicity-v1530 | ENUMERATED {ms3, ms4} | OPTIONAL |

-- Need R
]]
}

According to an embodiment, an SBFD slot or symbol may be used only in the DL slot in a TDD scheme, only in the UL slot, only in a flexible symbol, or configured regardless of the TDD pattern. For example, the SBFD pattern may represent information including in the DL, flexible, or UL slot in the TDD system.

According to an embodiment, information about the pattern, period, and frequency of a UL and DL slot or symbol representing SBFD information may include at least one of the following information:
A starting number of a slot configured as an SBFD slot and the number of consecutive slots;
A configuration through a bit string of a slot configured as an SBFD slot (e.g., if a first bit is 1, a first slot is configured as an SBFD slot);
A starting number of a symbol configured as an SBFD symbol within one slot (e.g., a pattern or index) and the number of consecutive symbols;
A configuration through a bit string of a symbol configured as an SBFD symbol within one slot (e.g., a pattern or index) (e.g., if a first bit is 1, a first slot is configured as an SBFD slot);
An indicator indicating whether a symbol is to be used as SBFD or non-SBFD, or mixed within one slot (e.g., a pattern or index);
Pattern information of a slot and symbol (e.g., a period or offset at which slots having the same SBFD symbol are repeated);
An indicator indicating a DL or UL subband or a guard band;
Information indicating an initial position of consecutive PRBs (e.g., an PRB unit indicating offset between point A and a starting PRB); and/or
Information indicating a bandwidth of a subband (e.g., the number of PRBs or a bandwidth in frequency units).

According to various embodiments, in case that the cells in service within one DU have different TDD or SBFD patterns, the DU may identify the TDD or SBFD pattern for each cell through the OAM interface and the like. Through the method described above, the DU may identify that the TDD pattern is different for each cell and predict inter-cell CLI.

According to an embodiment, furthermore, in case that the TDD or SBFD patterns of cells of different DUs or cells of different base stations are different, the DU may identify that the TDD or SBFD pattern of the cell being serviced by the DU is different from the TDD or SBFD pattern of the neighboring cell, based on the TDD or SBFD pattern information received through the F1AP message, and may predict inter-cell CLI.

According to an embodiment, in case that the cells in service within one CU have different TDD or SBFD patterns, the CU may identify the TDD or SBFD pattern for each cell according to a message transmitted through the F1AP interface. Through the method described above, the CU may identify that TDD patterns of cells serviced by one DU or different DUs are different from each other and predict inter-cell CLI.

As shown in FIGS. 4A to 4D, intra-cell CLI due to SBFD may be generated in one cell. A UL signal transmitted by any UE using the UL subband may cause interference to any UE using the DL subband.

FIGS. 6A and 6B illustrate an example of sharing pattern information of communication methods between CUs of different base stations and a signal flow according to an embodiment of the disclosure. More specifically, FIGS. 6A and 6B illustrate a method in which CUs of different base stations share TDD pattern information or SBFD pattern information to predict inter-cell CLI.

Referring to FIG. 6A, a first base station 601 and a second base station 611 may each include one CU 602 or 612, one DU 603 or 613, or one cell 604 or 614. Each cell 604 or 614 may provide a next-generation mobile communication service by using the TDD or the SBFD. For convenience of explanation, the first base station and the second base station are described as each including one DU and one cell.

The CU 602 of the first base station 601 may establish an XnAP connection with the CU 612 of the second base station 611 to exchange information through the Xn interface. Alternatively, the CU 612 of the second base station 611 may establish an XnAP connection with the CU 602 of the first base station 601 to exchange information through the Xn interface.

FIG. 6B below illustrate an XnAP message transmitted between the CU 621 of the first base station and the CU 631 of the second base station, and an F1AP message transmitted between the CU 621 of the first base station and the DU 622 between which the F1AP connection is established, and between the CU 631 of the second base station and the DU 632 between which the F1AP connection is established.

Referring to FIG. 6B, in step 623, the CU 621 of the first base station or the CU 631 of the second base station may transmit or receive XN SETUP REQUEST for an XnAP connection configuration.

In step 624, the CU 631 of the second base station or the CU 621 of the first base station which have received XN SETUP REQUEST may respond with XN SETUP RESPONSE. For convenience of explanation, in FIG. 6B, it is assumed a scenario where the CU 621 of the first base station transmits XN SETUP REQUEST to the CU 631 of the second base station.

In step 625, the DU 622 of the first base station may update information of a cell serviced by the base station.

In step 626, in case that information of a cell serviced by the base station has been updated, the DU 622 of the first base station may inform the CU 621 of the first base station the change through an F1AP gNB-DU configuration update message. According to an embodiment, a method for updating the information of the cell may employ the example of FIGS. 5A and 5B.

In step 627, in case that the information of the cell serviced by the base station has been updated, the CU 621 of the first base station may transmit a NG-RAN NODE CONFIGURATION UPDATE message through the XnAP to inform the CU 631 of the second base station of the change. Alternatively, in step 628, in case that information of a cell serviced by an opponent base station is required, the CU 621 of the first base station or the CU 631 of the second base station may transmit a NG-RAN NODE CONFIGURATION UPDATE message through the XnAP to request the cell information from the second base station 631 or the first base station 621.

In step 629, the second base station or the first base station having received NG-RAN NODE CONFIGURATION UPDATE may transmit a reception response or information requested through an NG-RAN NODE CONFIGURATION UPDATE ACKNOWLEDGE message.

In step 630, if the CU 631 of the second base station is required to update information of a neighboring cell to the DU 632, as shown in FIGS. 5A and 5B, the CU 631 of the second base station may transmit a gNB-CU configuration update message to the DU 632 through the F1AP to indicate the information.

According to various embodiments, the XnAP message (e.g., XN SETUP REQUEST, XN SETUP RESPONSE, NG-RAN NODE CONFIGURATION UPDATE, or NG-RAN NODE CONFIGURATION UPDATE ACKNOWLEDGE) described above may include at least one Served Cell Information NR. According to an embodiment, the served cell Information NR may include TDD information of a cell being serviced by the base station transmitting the XnAP message as shown in [Table 3] and may include information about the pattern and periodicity of a UL and DL slot or symbol. According to an embodiment, the pattern and periodicity of a UL and DL slot or symbol may be described as shown as [Table 1] or [Table 2].

According to various embodiments, in case that the TDD or SBFD pattern of a cell serviced by the CU 621 of the first base station is different from the TDD or SBFD pattern of a cell serviced by the CU 631 of the other base station, the CU 621 may identify that the TDD or SBFD pattern of the cell being serviced by the DU is different from the TDD or SBFD pattern of the neighboring cell, based on the TDD or SBFD pattern information received through XnAP messages, and may predict inter-cell CLI.

### 9.2.2.11 Served Cell Information NR

TABLE 3

| | | | | | | |
|---|---|---|---|---|---|---|
| | | | IE type and | Semantics | | Assigned |
| IE/Group Name | Presence | Range | reference | description | Criticality | Criticality |

. . .

| | | |
|---|---|---|
| CHOICE NR- | M | — |
| Mode-Info | | |

. . .

| | | | | | | |
|---|---|---|---|---|---|---|
| >TDD | | | | | | |
| >>TDD Info | | 1 | | | — | |
| >>>Frequency | M | | NR | | — | |
| Info | | | Frequency | | | |
| | | | Info | | | |
| | | | 9.2.2.19 | | | |
| >>>Transmission | M | | NR | | — | |
| Bandwidth | | | Transmission | | | |
| | | | Bandwidth | | | |
| | | | 9.2.2.20 | | | |
| >>>Intended | O | | 9.2.2.40 | | YES | ignore |
| TDD DL-UL | | | | | | |
| Configuration | | | | | | |
| NR | | | | | | |
| >>>TDD UL- | O | | OCTET | Includes the tdd- | YES | ignore |
| DL | | | STRING | UL-DL- | | |
| Configuration | | | | ConfigurationCommon | | |
| Common NR | | | | contained in the | | |
| | | | | SIB1 message as | | |
| | | | | defined in TS | | |
| | | | | 38.331 [10] | | |
| >>>Carrier List | O | | NR Carrier | If included, the | YES | ignore |
| | | | List | Transmission | | |
| | | | 9.2.2.63 | Bandwidth IE shall | | |
| | | | | be ignored. | | |
| >>>gNB-DU | O | | gNB-DU Cell | Contains FDD UL | YES | Ignore |
| Cell Resource | | | Resource | resource | | |
| Configuration- | | | Configuration | configuration of | | |
| TDD | | | 9.2.2.95 | gNB-DU's cell. | | |
| | | | | Only applicable if | | |
| | | | | the gNB-DU is an | | |
| | | | | IAB-DU or an IAB- | | |
| | | | | donor-DU. | | |

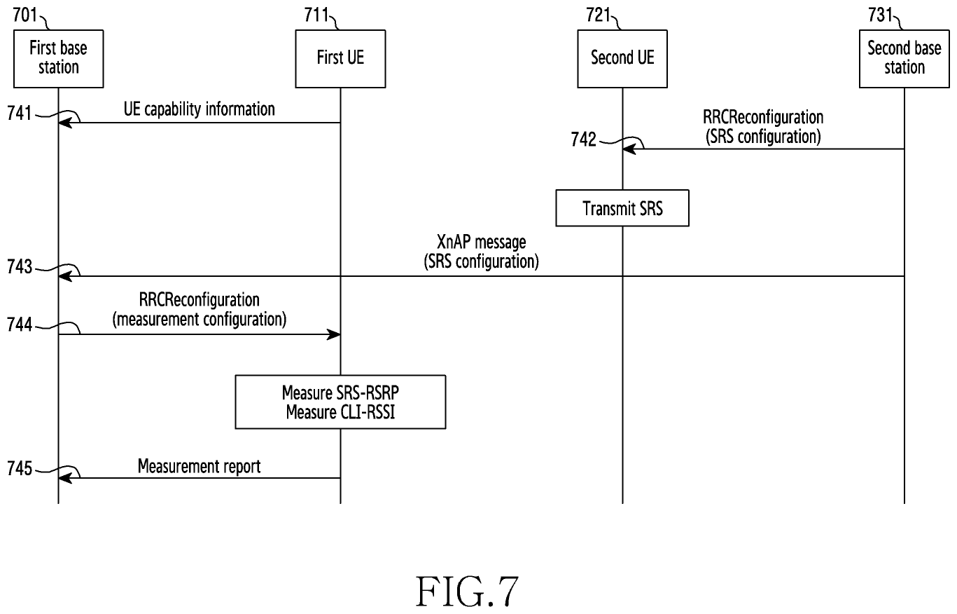

FIG. 7 illustrates a signal flow for measuring and reporting CLI by using an L3 measurement reporting framework according to an embodiment of the disclosure.

Referring to FIG. 7, a first base station 701 may service a first UE 711, and a second base station 731 may service a second UE 721. According to an embodiment, a cell for servicing the first UE 711 by the first base station 701 may have a TDD or SBFD pattern different from that of a cell for servicing the second UE 721 by the second base station 731. Here, as shown in the examples in FIGS. 5A to 6B, there may be inter-cell CLI or intra-cell CLI.

According to various embodiments, the first base station 701 may measure a signal transmitted by the second UE 721, which may cause interference to the first UE 711 and may report this to the base station. Through the procedure described above, the base stations may determine whether inter-cell CLI or intra-cell CLI is present. To this end, the first base station 701 may indicate a method and resource for measuring CLI to the first UE 711. The method for measuring CLI may be divided into sounding reference signal (SRS) measurement and received signal strength indicator (RSSI) measurement. The SRS measurement may include a method in which an SRS resource transmitted by the second UE 721 is measured by the first UE 711 and a result value is reported to the base station. The RSSI measurement may include a method in which the first UE 711 measures an RSSI of the indicated measurement resource and reports a result value to the base station. Here, a value measured with the RSSI may include a UL signal to be transmitted to the second UE 721. A method in which the first UE 711 reports a measurement result value to the first base station 701 may include a method using a measurement reporting triggering event, a method for periodic reporting, or a method using a combination of the two.

According to various embodiments, the first base station 701 may use an L3 measurement reporting framework to measure the CLI of the first UE 711.

In step 741, the first UE 711 may transmit UE capability information to the first base station 701 to transmit information about one of capability information indicating that the L3 measurement reporting framework may be used or capability information indicating that CLI may be measured. The first base station 701 may determine that the first UE 711 may measure CLI by using the L3 measurement reporting framework, based on the received capability information.

In step 742, the second base station 731 may indicate to the second UE 721 a configuration to transmit an SRS through an RRC message (e.g., RRCReconfiguration) for UL channel estimation of the second UE 721. According to an embodiment, each SRS resource may include srs-Resource, srs-SCS, refServCellIndex, and refBWP. Here, srs-Resource may include at least one of an SRS resource indicator (srs-ResourceId), the number of SRS ports (nrofSRS-ports), a ptrs port index (ptrs-PortIndex), a transmission resource combination (transmissionComb), time-axis resource mapping of the SRS (resourceMapping), frequency-axis resource mapping of the SRS (freqDomainPosition or freqDomainShift), frequency hopping information (freqHopping or groupOrSequenceHopping), or a transmission resource type (resource Type).

In step 743, the second base station 731 may transmit SRS resource information of the second UE 721 to the first base station 701 through the XnAP message. According to an embodiment, the information transmitted through the XnAP message may include at least one of information included in the RRC message for the SRS transmission configuration transmitted in step 742 or an identifier (e.g., XnAP UEID) of the second UE 721.

According to an embodiment, in case that the first base station 701 and the second base station 731 are the same base station and a serving cell of the first UE 711 and a serving cell of the second UE 721 are serviced by different DUs, each DU may transmit the SRS resource information of the second UE 721 to the CU through the F1AP message. In this case, the information included in the F1AP message may include at least one of information included in the RRC message for the SRS transmission configuration transmitted in step 742 or an identifier (e.g., GNB-DU F1AP UEID or GNB-CU F1AP UEID) of the second UE 721.

According to an embodiment, in case that the first base station 701 and the second base station 731 are the same base station and a serving cell of the first UE 711 and a serving cell of the second UE 721 are serviced by the same DU, the DU may transmit the SRS resource information of the second UE 721 to the CU through the F1AP message. In this case, the information included in the F1AP message may include at least one of information included in the RRC message for the SRS transmission configuration transmitted in step 742 or an identifier (e.g., GNB-DU F1AP UEID or GNB-CU F1AP UEID) of the second UE 721.

According to an embodiment, in case that a serving cell of the first UE 711 and a serving cell of the second UE 721 are identical to each other, the DU may transmit the SRS resource information of the second UE 721 to the CU through the F1AP message. In this case, the information included in the F1AP message may include at least one of information included in the RRC message for the SRS transmission configuration transmitted in step 742 or an identifier (e.g., GNB-DU F1AP UEID or GNB-CU F1AP UEID) of the second UE 721.

According to an embodiment, the CU of the first base station 701 may identify the SRS transmission information of the second UE 721 through the method described above. The CU of the first base station 701 may determine an SRS resource which the first UE 711 is required to measure.

According to various embodiments of the disclosure, in the L3 measurement reporting framework, an object to be measured and a condition to be reported may be indicated through a measurement configuration (MeasConfig). The measurement configuration includes measObjectToAddModList to add or change a measurement object, measObjectToRemoveList to delete a measurement object, reportConfigToAddModList to add or change a reporting condition, reportConfigToRemoveList to delete a reporting condition, measIdToAddModList to add or change a measurement identifier, or measIdToRemoveList to delete a measurement identifier, and may be represented as shown in [Table 4].

TABLE 4
- MeasConfig
The IE MeasConfig specifies measurements to be performed by the UE, and covers intra-frequency,
inter-frequency and inter-RAT mobility as well as configuration of measurement gaps.

MeasConfig information element

-- ASN1START
-- TAG-MEASCONFIG-START

| MeasConfig ::= | SEQUENCE { | |
|---|---|---|
| measObjectToRemoveList | MeasObjectToRemoveList | OPTIONAL, -- Need N |
| measObjectToAddModList | MeasObjectToAddModList | OPTIONAL, -- Need N |
| reportConfigToRemoveList | ReportConfigToRemoveList | OPTIONAL, -- Need N |
| reportConfigToAddModList | ReportConfigToAddModList | OPTIONAL, -- Need N |
| measIdToRemoveList | MeasIdToRemoveList | OPTIONAL, -- Need N |
| measIdToAddModList | MeasIdToAddModList | OPTIONAL, -- Need N |
| s-MeasureConfig | CHOICE { | |
| ssb-RSRP | RSRP-Range, | |
| csi-RSRP | RSRP-Range | |
| } | OPTIONAL, -- Need M | |
| quantityConfig | QuantityConfig | OPTIONAL, -- Need M |
| measGapConfig | MeasGapConfig | OPTIONAL, -- Need M |
| measGapSharingConfig | MeasGapSharingConfig | OPTIONAL, -- Need M |

```
  ...,
  [[
```

| | | |
|---|---|---|
| interFrequencyConfig-NoGap-r16 | ENUMERATED {true} | OPTIONAL -- Need R |

```
  ]],
  [[
```

| | | |
|---|---|---|
| effectiveMeasWindowConfig-r18 | SetupRelease {MeasWindowConfig-r18} | OPTIONAL |

-- Need M
]]
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF ReportConfigId |

-- TAG-MEASCONFIG-STOP
-- ASN1STOP

According to an embodiment, a measurement object list may include an identifier indicating a measurement object and at least one measObject indicating information about a measurement object, and each measurement object may be divided into NR, EUTRA, UTRA, SL, CLI, and the like depending on the purpose. The measurement object list may be represented as shown in [Table 5].

TABLE 5
- MeasObjectToAddModList
The IE MeasObjectToAddModList concerns a list of measurement objects to add or modify.

MeasObjectToAddModList information element

-- ASN1START
-- TAG-MEASOBJECTTOADDMODLIST-START

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16, |
| measObjectNR-SL-r18 | MeasObjectNR-SL-r18 |

}
}
-- TAG-MEASOBJECTTOADDMODLIST-STOP
-- ASN1STOP

According to an embodiment, a CLI measurement object may include a resource configuration for CLI measurement. A type of resource for CLI measurement may be configured as SRS and RSSI, and at least one SRS resource or RSSI resource may be included. The CLI measurement object may be represented as shown in [Table 6].

TABLE 6
- MeasObjectCLI
The IE MeasObjectCLI specifies information applicable for SRS-RSRP measurements and/or CLI-
RSSI measurements.

MeasObjectCLI information element

-- ASN1START
-- TAG-MEASOBJECTCLI-START

| | |
|---|---|
| MeasObjectCLI-r16 ::= | SEQUENCE { |
| cli-ResourceConfig-r16 | CLI-ResourceConfig-r16, |

...
}

| CLI-ResourceConfig-r16 ::= | SEQUENCE { | |
|---|---|---|
| srs-ResourceConfig-r16 | SetupRelease { SRS-ResourceListConfigCLI-r16 } | OPTIONAL, - |

- Need M

| | | |
|---|---|---|
| rssi-ResourceConfig-r16 | SetupRelease { RSSI-ResourceListConfigCLI-r16 } | OPTIONAL - |

- Need M
}
SRS-ResourceListConfigCLI-r16 ::= SEQUENCE (SIZE (1..maxNrofCLI-SRS-Resources-r16)) OF
SRS-ResourceConfigCLI-r16
RSSI-ResourceListConfigCLI-r16 ::= SEQUENCE (SIZE (1..maxNrofCLI-RSSI-Resources-r16)) OF
RSSI-ResourceConfigCLI-r16
SRS-ResourceConfigCLI-r16 ::= SEQUENCE {

| srs-Resource-r16 | SRS-Resource, | |
|---|---|---|
| srs-SCS-r16 | SubcarrierSpacing, | |
| refServCellIndex-r16 | ServCellIndex | OPTIONAL, -- Need S |

| | |
|---|---|
| refBWP-r16 | BWP-Id, |

...
}
RSSI-ResourceConfigCLI-r16 ::= SEQUENCE {

| rssi-ResourceId-r16 | RSSI-ResourceId-r16, | |
|---|---|---|
| rssi-SCS-r16 | SubcarrierSpacing, | |
| startPRB-r16 | INTEGER (0..2169), | |
| nrofPRBs-r16 | INTEGER (4..maxNrofPhysicalResourceBlocksPlus1), | |
| startPosition-r16 | INTEGER (0..13), | |
| nrofSymbols-r16 | INTEGER (1..14), | |
| rssi-PeriodicityAndOffset-r16 | RSSI-PeriodicityAndOffset-r16, | |
| refServCellIndex-r16 | ServCellIndex | OPTIONAL, -- Need S |

...
}

| | |
|---|---|
| RSSI-ResourceId-r16 ::= | INTEGER (0.. maxNrofCLI-RSSI-Resources-1-r16) |

RSSI-PeriodicityAndOffset-r16 ::= CHOICE {

| | |
|---|---|
| sl10 | INTEGER(0..9), |
| sl20 | INTEGER(0..19), |
| sl40 | INTEGER(0..39), |
| sl80 | INTEGER(0..79), |
| sl160 | INTEGER(0..159), |
| sl320 | INTEGER(0..319), |
| sl640 | INTEGER(0..639), |

...
}
-- TAG-MEASOBJECTCLI-STOP
-- ASN1STOP

According to an embodiment, each SRS resource may include srs-Resource, srs-SCS, refServCellIndex, and refBWP. Here, srs-Resource may include at least one of an SRS resource indicator (srs-ResourceId), the number of SRS ports (nrofSRS-ports), a ptrs port index (ptrs-PortIndex), a transmission resource combination (transmissionComb), time-axis resource mapping of the SRS (resourceMapping), frequency-axis resource mapping of the SRS (freqDomainPosition or freqDomainShift), frequency hopping information (freqHopping or groupOrSequenceHopping), or a transmission resource type (resourceType). Srs-Resource may be represented as shown in [Table 7].

TABLE 7

| SRS-Resource ::= | SEQUENCE { | |
|---|---|---|
| srs-ResourceId | SRS-ResourceId, | |
| nrofSRS-Ports | ENUMERATED {port1, ports2, ports4}, | |
| ptrs-PortIndex | ENUMERATED {n0, n1 } | OPTIONAL, -- Need R |

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, sequenceHopping }, |
| resourceType | CHOICE { |
| aperiodic | SEQUENCE { |

```
    ...
    },
```

| | |
|---|---|
| semi-persistent | SEQUENCE { |
| periodicityAndOffset-sp | SRS-PeriodicityAndOffset, |

```
    ...
    },
```

| | |
|---|---|
| periodic | SEQUENCE { |
| periodicityAndOffset-p | SRS-PeriodicityAndOffset, |

```
    ...
    }
  },
```

| sequenceId | INTEGER (0..1023), | |
|---|---|---|
| spatialRelationInfo | SRS-SpatialRelationInfo | OPTIONAL, -- Need R |

```
  ...,
  [[
```

| sequenceId | INTEGER (0..1023), | |
|---|---|---|
| spatialRelationInfo | SRS-SpatialRelationInfo | OPTIONAL, -- Need R |

```
  ...,
  [[
```

| | |
|---|---|
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |
| } | OPTIONAL -- Need R |

```
  ]],
  [[
```

| | | |
|---|---|---|
| spatialRelationInfo-PDC-r17 | SetupRelease { SpatialRelationInfo-PDC-r17 } | OPTIONAL, -- |

Need M

| | |
|---|---|
| resourceMapping-r17 | SEQUENCE { |
| startPosition-r17 | INTEGER (0..13), |
| nrofSymbols-r17 | ENUMERATED {n1, n2, n4, n8, n10, n12, n14}, |
| repetitionFactor-r17 | ENUMERATED {n1, n2, n4, n5, n6, n7, n8, n10, n12, n14} |
| } | OPTIONAL, -- Need R |
| partialFreqSounding-r17 | SEQUENCE { |
| startRBIndexFScaling-r17 | CHOICE{ |

```
    startRBIndexAndFreqScalingFactor2-r17 INTEGER (0..1),
    startRBIndexAndFreqScalingFactor4-r17 INTEGER (0..3)
    },
```

| | | |
|---|---|---|
| enableStartRBHopping-r17 | ENUMERATED {enable} | OPTIONAL -- Need R |

| | |
|---|---|
| } | OPTIONAL, -- Need R |
| transmissionComb-n8-r17 | SEQUENCE { |
| combOffset-n8-r17 | INTEGER (0..7), |
| cyclicShift-n8-r17 | INTEGER (0..5) |
| } | OPTIONAL, -- Need R |
| srs-TCI-State-r17 | CHOICE { |
| srs-UL-TCI-State | TCI-UL-StateId-r17, |
| srs-DLorJointTCI-State | TCI-StateId |
| } | OPTIONAL -- Need R |

```
  ]],
  [[
```

| | | |
|---|---|---|
| repetitionFactor-v1730 | ENUMERATED {n3} | OPTIONAL, -- Need R |

| | |
|---|---|
| srs-DLorJointTCI-State-v1730 | SEQUENCE { |
| cellAndBWP-r17 | ServingCellAndBWP-Id-r17 |
| } | OPTIONAL -- Cond DLorJointTCI-SRS |

```
  ]],
  [[
```

| nrofSRS-Ports-n8-r18 | ENUMERATED {ports8, ports8tdm} | OPTIONAL, -- Need R |
|---|---|---|
| combOffsetHopping-r18 | SEQUENCE { | |
| hoppingId-r18 | INTEGER (0..1023) | OPTIONAL, -- Need R |
| hoppingSubset-r18 | CHOICE { | |
| transmissionComb-n4 | BIT STRING (SIZE (4)), | |
| transmissionComb-n8 | BIT STRING (SIZE (8)) | |
| } | OPTIONAL, -- Need R | |
| hoppingWithRepetition-r18 | ENUMERATED {symbol, repetition} | OPTIONAL -- Need |

R

| } | OPTIONAL, -- Need R | |
|---|---|---|
| cyclicShiftHopping-r18 | SEQUENCE { | |
| hoppingId-r18 | INTEGER (0..1023) | OPTIONAL, -- Need R |
| hoppingSubset-r18 | CHOICE { | |
| transmissionComb-n2 | BIT STRING (SIZE (8)), | |
| transmissionComb-n4 | BIT STRING (SIZE (12)), | |
| transmissionComb-n8 | BIT STRING (SIZE (6)) | |
| } | OPTIONAL, -- Need R | |
| hoppingFinerGranularity-r18 | ENUMERATED {enable} | OPTIONAL -- Need R |

| | |
|---|---|
| } | OPTIONAL -- Need R |

]]
}

According to an embodiment, each RSSI resource may be distinguished by an identifier (rssi-ResourceId) and may include at least one of SCS of an RSSI resource (rssi-SCS), a starting PRB position and the number of PRBs of an RSSI resource (startPRB, nrofPRBs), a starting symbol position and the number of symbols of an RSSI resource (startPosition, nrofSymbols), a periodicity and offset of an RSSI resource (rssi-PeriodictyAndOffset), or a frequency reference point cell (refServCellIndex).

According to an embodiment, a measurement reporting list may include an identifier indicating measurement reporting and at least one reportConfig indicating a measurement reporting condition, and each measurement object may be divided into NR, Inter-RAT, SL and the like depending on the purpose. The measurement reporting list may be represented as shown in [Table 8].

TABLE 8
- ReportConfigToAddModList
The IE ReportConfigToAddModList concerns a list of reporting configurations to add or modify.

ReportConfigToAddModList information element

-- ASN1START
-- TAG-REPORTCONFIGTOADDMODLIST-START

| | |
|---|---|
| ReportConfigToAddModList | SEQUENCE (SIZE (1..maxReportConfigId)) OF |

ReportConfigToAddMod

| | |
|---|---|
| ReportConfigToAddMod ::= | SEQUENCE { |
| reportConfigId | ReportConfigId, |
| reportConfig | CHOICE { |
| reportConfigNR | ReportConfigNR, |

...,

| | |
|---|---|
| reportConfigInterRAT | ReportConfigInterRAT, |
| reportConfigNR-SL-r16 | ReportConfigNR-SL-r16 |

}
}
-- TAG-REPORTCONFIGTOADDMODLIST-STOP
-- ASN1STOP

According to an embodiment, an NR reporting configuration may include a measurement reporting configuration targeting NR. Measurement configurations for CLI reporting may include measurement reporting triggering event-based reporting and periodic reporting. Measurement reporting triggering events may include, but are not limited to, SRS-RSRP or CLI-RSSI measured by the UE being above a specific threshold, or may be events that trigger measurement reporting in other ways not described in the disclosure. If a UE is configured to report periodically and there is a measurement result to report, reporting through measurement report may proceed at configured intervals (reportInterval). Measurement reporting may proceed as many times as configured (reportAmount). The CLI reporting configuration among the NR reporting configuration may be represented as shown in [Table 9].

TABLE 9

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| rxTxPeriodical-r17 | RxTxPeriodical-r17, |
| reportOnScellActivation-r18 | ReportOnScellActivation-r18 |

}
}

| | |
|---|---|
| CLI-EventTriggerConfig-r16 ::= | SEQUENCE { |
| eventId-r16 | CHOICE { |
| eventI1-r16 | SEQUENCE { |
| i1-Threshold-r16 | MeasTriggerQuantityCLI-r16, |
| reportOnLeave-r16 | BOOLEAN, |
| hysteresis-r16 | Hysteresis, |
| timeToTrigger-r16 | TimeToTrigger |

```
    },
  ...
  },
```

| | |
|---|---|
| reportInterval-r16 | ReportInterval, |
| reportAmount-r16 | ENUMERATED {r1, r2, r4, r8, r16, r32, r64, infinity}, |
| maxReportCLI-r16 | INTEGER (1..maxCLI-Report-r16), |

...
}
CLI-PeriodicalReportConfig-r16 ::= SEQUENCE {

| | |
|---|---|
| reportInterval-r16 | ReportInterval, |
| reportAmount-r16 | ENUMERATED {r1, r2, r4, r8, r16, r32, r64, infinity}, |
| reportQuantityCLI-r16 | MeasReportQuantityCLI-r16, |
| maxReportCLI-r16 | INTEGER (1..maxCLI-Report-r16), |

...
}
MeasTriggerQuantityCLI-r16 ::= CHOICE {

| | |
|---|---|
| srs-RSRP-r16 | SRS-RSRP-Range-r16, |
| cli-RSSI-r16 | CLI-RSSI-Range-r16 |

}

According to an embodiment, the first base station 701 may transmit an SRS pattern transmitted by the second UE 721 to the first UE 711 and accordingly, may indicate the UE to perform measurement. The SRS pattern may be transmitted as shown in [Table 7] described above. The first base station 701 may configure the SRS pattern included in the CLI measurement object (measObjectCLI) to the first UE 711. In addition, the first base station 701 may configure the reporting configuration (reportConfig) to the first UE 711 so as to indicate a method for the first UE 711 to report the measured SRS-RSRP to the first base station 701. The first base station 701 may configure, to the first UE 711, measurement in which measObject and reportConfig are combined as shown in [Table 10] described above. In addition, the first base station 701 may configure an RSSI resource to the first UE 711 and indicate to measure the RSSI in the corresponding resource. The RSSI resource may be transmitted as shown in [Table 6] described above. The first base station 701 may configure the RSSI resource included in the CLI measurement object (measObjectCLI) to the first UE 711. In addition, the first base station 701 may configure the reporting configuration (reportConfig) to the first UE 711 so as to indicate a method for the first UE 711 to report the measured CLI-RSSI to the first base station 701.

TABLE 10

| | |
|---|---|
| - | MeasIdToAddModList |

The IE MeasIdToAddModList concerns a list of measurement identities to add or modify, with for each
entry the measId, the associated measObjectId and the associated reportConfigId.

MeasIdToAddModList information element

-- ASN1START
-- TAG-MEASIDTOADDMODLIST-START

| | |
|---|---|
| MeasIdToAddModList ::= | SEQUENCE (SIZE (1..maxNrofMeasId)) OF MeasIdToAddMod |
| MeasIdToAddMod ::= | SEQUENCE { |
| measId | MeasId, |
| measObjectId | MeasObjectId, |
| reportConfigId | ReportConfigId |

}
-- TAG-MEASIDTOADDMODLIST-STOP
-- ASN1STOP

In step 744, the first base station 701 may indicate a measurement object and a reporting condition to the first UE 711 through an RRC message (e.g., RRCReconfiguration).

In step 745, the first UE 711 may perform measurement with respect to the measurement object indicated by the first base station 701 through the RRC message and report the measurement to the first base station 701.

According to various embodiments of the disclosure, the first UE 711 may perform measurement periodically or when the measurement reporting event has been satisfied as indicated by the first base station 701 through the RRC message in step 744, and therefore, may transmit a measurement result included in the RRC message (e.g., measurement report) to the base station therethrough. According to an embodiment, Measurement report may include at least one of following information. The Measurement report may be represented as shown in [Table 11]:
A measurement identifier (e.g., measId);
A measurement result of a serving cell (e.g., a measurement result of a cell indicated by servingCellMO);
Rx beam info of a UE (e.g., TCI state ID);
A CLI measurement result;
1) An SRS-RSRP measurement result (e.g., an SRS resource identifier, SRS-RSRP (dBm)): a case in which the measurement reporting event is satisfied due to the SRS-RSRP or it is indicated to measure with the SRS-RSRP may be included;
2) A CLI-RSSI measurement result (e.g., an RSSI resource identifier, CLI-RSSI (dBm)): a case in which the measurement reporting event is satisfied due to the CLI-RSSI or it is indicated to measure with the SRS-RSRP may be included; and/or
An indicator indicating measurement report first transmitted after satisfying the measurement reporting event.

TABLE 11

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- Contains PC5 SL-MeasResultListRelay- |

r17

| | |
|---|---|
| } | OPTIONAL, |

```
  ...,
  [[
```

| | |
|---|---|
| measResultServFreqListEUTRA-SCG | MeasResultServFreqListEUTRA-SCG |

OPTIONAL,

| | | |
|---|---|---|
| measResultServFreqListNR-SCG | MeasResultServFreqListNR-SCG | OPTIONAL, |
| measResultSFTD-EUTRA | MeasResultSFTD-EUTRA | OPTIONAL, |
| measResultSFTD-NR | MeasResultCellSFTD-NR | OPTIONAL |

```
  ]],
  [[
```

| | | |
|---|---|---|
| measResultCellListSFTD-NR | MeasResultCellListSFTD-NR | OPTIONAL |

```
  ]],
  [[
```

| | | |
|---|---|---|
| measResultForRSSI-r16 | MeasResultForRSSI-r16 | OPTIONAL, |
| locationInfo-r16 | LocationInfo-r16 | OPTIONAL, |
| ul-PDCP-DelayValueResultList-r16 | UL-PDCP-DelayValueResultList-r16 | OPTIONAL, |
| measResultsSL-r16 | MeasResultsSL-r16 | OPTIONAL, |
| measResultCLI-r16 | MeasResultCLI-r16 | OPTIONAL |

```
  ]],
  [[
```

| | | |
|---|---|---|
| measResultRxTxTimeDiff-r17 | MeasResultRxTxTimeDiff-r17 | OPTIONAL, |
| sl-MeasResultServingRelay-r17 | OCTET STRING | OPTIONAL, |

-- Contains PC5 SL-MeasResultRelay-r17

| | |
|---|---|
| ul-PDCP-ExcessDelayResultList-r17 | UL-PDCP-ExcessDelayResultList-r17 |

OPTIONAL,

| | | |
|---|---|---|
| coarseLocationInfo-r17 | OCTET STRING | OPTIONAL |

```
  ]],
  [[
```

| | | |
|---|---|---|
| altitudeUE-r18 | Altitude-r18 | OPTIONAL |

]]
}

| | |
|---|---|
| MeasResultServMOList ::= | SEQUENCE (SIZE (1..maxNrofServingCells)) OF |

MeasResultServMO

| MeasResultServMO ::= | SEQUENCE { | |
|---|---|---|
| servCellId | ServCellIndex, | |
| measResultBestNeighCell | MeasResultNR, | |
| measResultServingCell | MeasResultNR | OPTIONAL, |

...
}

| MeasResultListNR ::= | SEQUENCE (SIZE (1..maxCellReport)) OF MeasResultNR | |
|---|---|---|
| MeasResultNR ::= | SEQUENCE { | |
| physCellId | PhysCellId | OPTIONAL, |
| measResult | SEQUENCE { | |
| cellResults | SEQUENCE{ | |
| resultsSSB-Cell | MeasQuantityResults | OPTIONAL, |
| resultsCSI-RS-Cell | MeasQuantityResults | OPTIONAL |

},

| rsIndexResults | SEQUENCE{ | |
|---|---|---|
| resultsSSB-Indexes | ResultsPerSSB-IndexList | OPTIONAL, |
| resultsCSI-RS-Indexes | ResultsPerCSI-RS-IndexList | OPTIONAL |

| | |
|---|---|
| } | OPTIONAL |

```
  },
  ...,
  [[
```

| | | |
|---|---|---|
| cgi-Info | CGI-InfoNR | OPTIONAL |

```
  ]],
  [[
```

| choCandidate-r17 | ENUMERATED {true} | OPTIONAL, |
|---|---|---|
| choConfig-r17 | SEQUENCE (SIZE (1..2)) OF CondTriggerConfig-r16 | OPTIONAL, |
| triggeredEvent-r17 | SEQUENCE { | |
| timeBetweenEvents-r17 | TimeBetweenEvent-r17 | OPTIONAL, |

| | |
|---|---|
| firstTriggeredEvent-r17 | ENUMERATED {condFirstEvent, condSecondEvent} |

OPTIONAL

| | |
|---|---|
| } | OPTIONAL |

]]
}

| MeasResultListEUTRA ::= | SEQUENCE (SIZE (1..maxCellReport)) OF MeasResultEUTRA | |
|---|---|---|
| MeasResultEUTRA ::= | SEQUENCE { | |
| eutra-PhysCellId | PhysCellId, | |
| measResult | MeasQuantityResultsEUTRA, | |
| cgi-Info | CGI-InfoEUTRA | OPTIONAL, |

...
}

| | |
|---|---|
| MultiBandInfoListEUTRA ::= | SEQUENCE (SIZE (1..maxMultiBands)) OF |

FreqBandIndicatorEUTRA

| MeasQuantityResults ::= | SEQUENCE { | |
|---|---|---|
| rsrp | RSRP-Range | OPTIONAL, |
| rsrq | RSRQ-Range | OPTIONAL, |
| sinr | SINR-Range | OPTIONAL |

}

| MeasQuantityResultsEUTRA ::= SEQUENCE { | | |
|---|---|---|
| rsrp | RSRP-RangeEUTRA | OPTIONAL, |
| rsrq | RSRQ-RangeEUTRA | OPTIONAL, |
| sinr | SINR-RangeEUTRA | OPTIONAL |

}

| | |
|---|---|
| ResultsPerSSB-IndexList ::= | SEQUENCE (SIZE (1..maxNrofIndexesToReport2)) OF |

ResultsPerSSB-Index

| ResultsPerSSB-Index ::= | SEQUENCE { | |
|---|---|---|
| ssb-Index | SSB-Index, | |
| ssb-Results | MeasQuantityResults | OPTIONAL |

}
ResultsPerCSI-RS-IndexList::= SEQUENCE (SIZE (1..maxNrofIndexesToReport2)) OF
ResultsPerCSI-RS-Index
ResultsPerCSI-RS-Index ::= SEQUENCE {

| csi-RS-Index | CSI-RS-Index, | |
|---|---|---|
| csi-RS-Results | MeasQuantityResults | OPTIONAL |

}

| MeasResultCLI-r16 ::= | SEQUENCE { | |
|---|---|---|
| measResultListSRS-RSRP-r16 | MeasResultListSRS-RSRP-r16 | OPTIONAL, |
| measResultListCLI-RSSI-r16 | MeasResultListCLI-RSSI-r16 | OPTIONAL |

}
MeasResultListSRS-RSRP-r16 ::= SEQUENCE (SIZE (1.. maxCLI-Report-r16)) OF
MeasResultSRS-RSRP-r16
MeasResultSRS-RSRP-r16 ::= SEQUENCE {

| | |
|---|---|
| srs-ResourceId-r16 | SRS-ResourceId, |
| srs-RSRP-Result-r16 | SRS-RSRP-Range-r16 |

}
MeasResultListCLI-RSSI-r16 ::= SEQUENCE (SIZE (1.. maxCLI-Report-r16)) OF MeasResultCLI-
RSSI-r16
MeasResultCLI-RSSI-r16 ::= SEQUENCE {

| | |
|---|---|
| rssi-ResourceId-r16 | RSSI-ResourceId-r16, |
| cli-RSSI-Result-r16 | CLI-RSSI-Range-r16 |

}

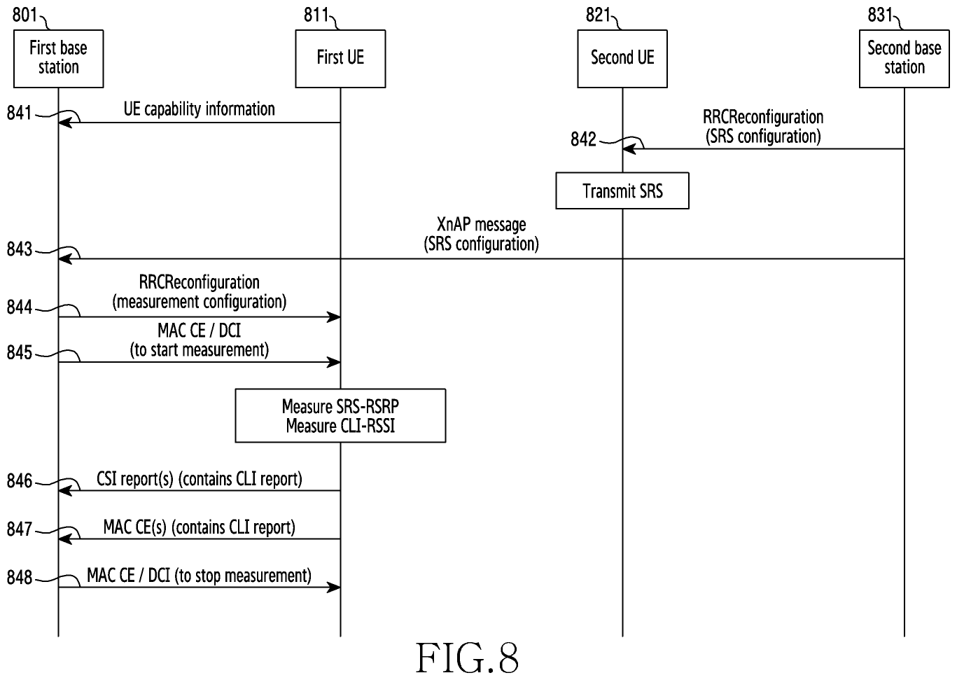

FIG. 8 illustrates a signal flow of measuring and reporting CLI by using an L1 measurement report framework according to an embodiment of the disclosure.

Referring to FIG. 8, a first base station 801 may service a first UE 811, and a second base station 831 may service a second UE 821. According to an embodiment, a cell for servicing the first UE 811 by the first base station 801 may have a TDD or SBFD pattern different from that of a cell for servicing the second UE 821 by the second base station 831. Here, as shown in the examples in FIGS. 5A to 6B, there may be inter-cell CLI or intra-cell CLI.

According to various embodiments, the first base station 801 may measure a signal transmitted by the second UE 821, which may cause interference to the first UE 811 and may report this to the base station. Through the procedure described above, the base stations may determine whether inter-cell CLI or intra-cell CLI is present. To this end, the first base station 801 may indicate a method and resource for measuring CLI to the first UE 811. The method for measuring CLI may be divided into sounding reference signal (SRS) measurement and received signal strength indicator (RSSI) measurement. The SRS measurement may include a method in which an SRS resource transmitted by the second UE 821 is measured by the first UE 811 and a result value is reported to the base station. The RSSI measurement may include a method in which the first UE 811 measures an RSSI of the indicated measurement resource and reports a result value to the base station. Here, a value measured with the RSSI may include a UL signal to be transmitted to the second UE 821. A method in which the first UE 811 reports a measurement result value to the first base station 801 may include a method using a measurement reporting triggering event, a method for periodic reporting, or a method using a combination of the two.

According to various embodiments, the first base station 801 may use an L1 measurement reporting framework to measure the CLI of the first UE 811.

In step 841, the first UE 811 may transmit UE capability information to the first base station 801 to transmit information about one of capability information indicating that the L1 measurement reporting framework may be used or capability information indicating that CLI may be measured. The first base station 801 may determine that the first UE 811 may measure CLI by using the L1 measurement reporting framework, based on the received capability information.

In step 842, the second base station 831 may indicate to the second UE 721 a configuration to transmit an SRS through an RRC message (e.g., RRCReconfiguration) for UL channel estimation of the second UE 821. Each SRS resource may include srs-Resource srs-SCS, refServCellIndex, and refBWP. Here, srs-Resource may include at least one of an SRS resource indicator (srs-ResourceId), the number of SRS ports (nrofSRS-ports), a ptrs port index (ptrs-PortIndex), a transmission resource combination (transmissionComb), time-axis resource mapping of the SRS (resourceMapping), frequency-axis resource mapping of the SRS (freqDomainPosition or freqDomainShift), frequency hopping information (freqHopping or groupOrSequenceHopping), or a transmission resource type (resourceType).

In step 843, the second base station 831 may transmit SRS resource information of the second UE 821 to the first base station 801 through the XnAP message. According to an embodiment, the information transmitted through the XnAP message may include at least one of information included in the RRC message for the SRS transmission configuration transmitted in step 842 or an identifier (e.g., XnAP UEID) of the second UE 821.

According to an embodiment, in case that the first base station 801 and the second base station 831 are the same base station and a serving cell of the first UE 811 and a serving cell of the second UE 821 are serviced by different DUs, each DU may transmit the SRS resource information of the second UE 821 to the CU through the F1AP message. In this case, the information included in the F1AP message may include at least one of information included in the RRC message for the SRS transmission configuration transmitted in step 842 or an identifier (e.g., GNB-DU F1AP UEID or GNB-CU F1AP UEID) of the second UE 821.

According to an embodiment, in case that the first base station 801 and the second base station 831 are the same base station and a serving cell of the first UE 811 and a serving cell of the second UE 821 are serviced by the same DU, the DU may transmit the SRS resource information of the second UE 821 to the CU through the F1AP message. In this case, the information included in the F1AP message may include at least one of information included in the RRC message for the SRS transmission configuration transmitted in step 842 or an identifier (e.g., GNB-DU F1AP UEID or GNB-CU F1AP UEID) of the second UE 821.

According to an embodiment, in case that a serving cell of the first UE 811 and a serving cell of the second UE 821 are identical to each other, the DU may transmit the SRS resource information of the second UE 821 to the CU through the F1AP message. In this case, the information included in the F1AP message may include at least one of information included in the RRC message for the SRS transmission configuration transmitted in step 842 or an identifier (e.g., GNB-DU F1AP UEID or GNB-CU F1AP UEID) of the second UE 821.

According to an embodiment, the CU of the first base station 801 may identify the SRS transmission information of the second UE 821 through the method described above. The CU of the first base station 801 may determine an SRS resource which the first UE 811 is required to measure.

According to various embodiments of the disclosure, the first base station 801 may use the L1 measurement reporting framework for CLI measurement. The first base station 801 may transmit an SRS pattern transmitted by the second UE 821 to the first UE 811 and accordingly, may indicate the UE to perform measurement. The SRS pattern may be transmitted as shown in [Table 7] described above. The first base station 801 may configure the SRS pattern included in the CLI measurement object (CSI-MeasConfig) to the first UE 811. The CSI measurement configuration may be configured for the purpose of measuring non zero power (NZP) channel state information reference signal (CSI-RS), or channel state information interference management (CSI-IM), SSB, Scell, LTM, and the like. CSI-MeasConfig may be represented as shown in [Table 12].

```
TABLE 12
    - CSI-MeasConfig
The IE CSI-MeasConfig is used to configure CSI-RS (reference signals) belonging to the serving cell
in which CSI-MeasConfig is included, channel state information reports to be transmitted on PUCCH
on the serving cell in which CSI-MeasConfig is included and channel state information reports on
PUSCH triggered by DCI received on the serving cell in which CSI-MeasConfig is included. See also
TS 38.214 [19], clause 5.2.
      CSI-MeasConfig information element
-- ASN1START
-- TAG-CSI-MEASCONFIG-START
CSI-MeasConfig ::= SEQUENCE {
  nzp-CSI-RS-ResourceToAddModList SEQUENCE (SIZE (1..maxNrofNZP-CSI-RS-Resources))
OF NZP-CSI-RS-Resource OPTIONAL, -- Need N
  nzp-CSI-RS-ResourceToReleaseList SEQUENCE (SIZE (1..maxNrofNZP-CSI-RS-Resources)) OF
NZP-CSI-RS-ResourceId OPTIONAL, -- Need N
  nzp-CSI-RS-ResourceSetToAddModList SEQUENCE (SIZE (1..maxNrofNZP-CSI-RS-
ResourceSets)) OF NZP-CSI-RS-ResourceSet
        OPTIONAL, -- Need N
  nzp-CSI-RS-ResourceSetToReleaseList SEQUENCE (SIZE (1..maxNrofNZP-CSI-RS-
ResourceSets)) OF NZP-CSI-RS-ResourceSetId
        OPTIONAL, -- Need N
  csi-IM-ResourceToAddModList SEQUENCE (SIZE (1..maxNrofCSI-IM-Resources)) OF CSI-IM-
Resource OPTIONAL, -- Need N
  csi-IM-ResourceToReleaseList SEQUENCE (SIZE (1..maxNrofCSI-IM-Resources)) OF CSI-IM-
ResourceId OPTIONAL, -- Need N
  csi-IM-ResourceSetToAddModList SEQUENCE (SIZE (1..maxNrofCSI-IM-ResourceSets)) OF
CSI-IM-ResourceSet OPTIONAL, -- Need N
  csi-IM-ResourceSetToReleaseList SEQUENCE (SIZE (1..maxNrofCSI-IM-ResourceSets)) OF CSI-
IM-ResourceSetId OPTIONAL, -- Need N
  csi-SSB-ResourceSetToAddModList SEQUENCE (SIZE (1..maxNrofCSI-SSB-ResourceSets)) OF
CSI-SSB-ResourceSet OPTIONAL, -- Need N
  csi-SSB-ResourceSetToReleaseList SEQUENCE (SIZE (1..maxNrofCSI-SSB-ResourceSets)) OF
CSI-SSB-ResourceSetId OPTIONAL, -- Need N
csi-ResourceConfigToAddModList SEQUENCE (SIZE (1..maxNrofCSI-ResourceConfigurations))
OF CSI-ResourceConfig
        OPTIONAL, -- Need N
  csi-ResourceConfigToReleaseList SEQUENCE (SIZE (1..maxNrofCSI-ResourceConfigurations))
OF CSI-ResourceConfigId
        OPTIONAL, -- Need N
  csi-ReportConfigToAddModList SEQUENCE (SIZE (1..maxNrofCSI-ReportConfigurations)) OF
CSI-ReportConfig OPTIONAL, -- Need N
  csi-ReportConfigToReleaseList SEQUENCE (SIZE (1..maxNrofCSI-ReportConfigurations)) OF
CSI-ReportConfigId
        OPTIONAL, -- Need N
  reportTriggerSize INTEGER (0..6) OPTIONAL, -- Need M
  aperiodicTriggerStateList SetupRelease { CSI-AperiodicTriggerStateList } OPTIONAL, -
- Need M
  semiPersistentOnPUSCH-TriggerStateList SetupRelease { CSI-SemiPersistentOnPUSCH-
TriggerStateList } OPTIONAL, -- Need M
  ...,
  [[
  reportTriggerSizeDCI-0-2-r16 INTEGER (0..6) OPTIONAL -- Need R
  ]],
  [[
  sCellActivationRS-ConfigToAddModList-r17 SEQUENCE (SIZE (1..maxNrofSCellActRS-r17)) OF
SCellActivationRS-Config-r17 OPTIONAL, -- Need N
  sCellActivationRS-ConfigToReleaseList-r17 SEQUENCE (SIZE (1..maxNrofSCellActRS-r17)) OF
SCellActivationRS-ConfigId-r17 OPTIONAL -- Need N
  ]],
  [[
  ltm-CSI-ReportConfigToAddModList-r18 SEQUENCE (SIZE (1..maxNrofLTM-CSI-
ReportConfigurations-r18)) OF LTM-CSI-ReportConfig-r18
        OPTIONAL, -- Need N
  ltm-CSI-ReportConfigToReleaseList-r18 SEQUENCE (SIZE (1..maxNrofLTM-CSI-
ReportConfigurations-r18)) OF LTM-CSI-ReportConfigId-r18
        OPTIONAL -- Need N
  ]]
}
-- TAG-CSI-MEASCONFIG-STOP
-- ASN1STOP
```

According to an embodiment, to add or change the CLI measurement reporting configuration, the CLI measurement configuration may be configured in the form of a list including at least one CLI measurement configuration, for example, as shown below.
cli-CSI-ReportConfigToAddModList SEQUENCE (SIZE (1 . . . maxNrofCLI-CSI-ReportConfigurations)) OF CLI-CSI-ReportConfig.

According to an embodiment, maxNrOfCLI-CSI-ReportConfiguration may indicate a maximum number (e.g., 48) of CLI measurement reporting configurations that may be configured for one UE.

According to an embodiment, CLI-CSI-ReportConfig indicates the CLI measurement configuration reported as one interference, and may include one or more of the following information.
cli-CSI-ReportConfigId: corresponds to an identifier for distinguishing the CLI measurement configuration and a maximum value may be identical to maxNrOfCLI-CSI-ReportConfiguration.
cli-ResourcesForChannelMeasurement: indicates the CLI measurement resource.
cli-ReportConfigType: indicates a configuration for the CLI measurement reporting and may correspond to at least one of periodic, semiPersistentOnPUCCH, semiPersistentOnPUSCH, aperiodic, and event-based.
cli-ReportContent: may indicate a content to be included in the CLI measurement reporting.

According to an embodiment, cli-ResourcesForChannelMeasurement indicates at least one measurement resource to be measured and may include an identifier (e.g., cli-CSI-ResourceConfigId) that distinguishes the measurement object (e.g., cli-CSI-ResourceConfigId) and a set (e.g., cli-CSI-ResourceSet) of at least one measurement resource. The set may be organized in the form of a list including one or more measurement resources including some or all of the information included in the SRS-ResourceConfigCLI or RSSI-ResourceConfigCLI exemplified in FIG. 7.

According to an embodiment, cli-CSI-ResourceSet may represent the SRS resource or RSSI resource to be measured, and the information included may be similar to measObjectCLI in [Table 6]. In addition, the first base station 801 may indicate TCI (transmission configuration indication)-StateId to indicate a beam (e.g., a resource) to be measured by the first UE 811. TCI-StateId may include an identifier of TCI-state that represents an antenna port having a quasi-co-located (QCL) relationship with a particular channel (e.g., reference signal) transmitted by the base station. For example, the base station may indicate an antenna port having a QCL relationship to a particular beam transmitted by the base station, thereby indicating to the UE to measure a CLI resource through the antenna port receiving the corresponding beam.

According to an embodiment, cli-ReportConfigType may indicate a resource for the first UE 811 to transmit the CSI reporting. The resources for transmitting the CSI reporting may be divided and configured as periodic representing a periodic resource, semiPersistentOnPUCCH representing a periodic resource that is transmitted in a PUCCH that may be started or stopped by an indication (e.g., downlink control information (DCI) or medium access control (MAC) control element (CE)) from the first base station 801, aperiodic representing a resource that is transmitted on a one-time basis at an indication (e.g., DCI or MAC CE) from the first base station 801, or event-based representing a resource that may be transmitted by the UE when a specific L1 measurement reporting event is satisfied. In this case, cli-ReportConfigType may be represented as shown in [Table 13].

TABLE 13

| | |
|---|---|
| cli-ReportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI-Resource |

},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI-Resource |

},

| | |
|---|---|
| semiPersistentOnPUSCH | SEQUENCE { |
| reportSlotConfig | CSI-ReportPeriodicityAndOffset, |
| reportSlotOffsetList | SEQUENCE (SIZE (1.. maxNrofUL-Allocations-r16)) OF INTEGER |

(0..128),

| | |
|---|---|
| reportSlotOffsetListDCI-0-2 | SEQUENCE (SIZE (1.. maxNrofUL-Allocations-r16)) OF |

INTEGER (0..128),

| | |
|---|---|
| reportSlotOffsetListDCI-0-1 | SEQUENCE (SIZE (1.. maxNrofUL-Allocations-r16)) OF |

INTEGER (0..128),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1.. maxNrofUL-Allocations-r16)) OF INTEGER |

(0..128),

| | |
|---|---|
| reportSlotOffsetListDCI-0-2 | SEQUENCE (SIZE (1.. maxNrofUL-Allocations-r16)) OF |

INTEGER (0..128),

| | |
|---|---|
| reportSlotOffsetListDCI-0-1 | SEQUENCE (SIZE (1.. maxNrofUL-Allocations-r16)) OF |

INTEGER (0..128)
},

| | |
|---|---|
| event-based | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource

| | |
|---|---|
| reportSlotOffsetList | SEQUENCE (SIZE (1.. maxNrofUL-Allocations-r16)) OF INTEGER |

(0..128),

| | |
|---|---|
| reportSlotOffsetListDCI-0-2 | SEQUENCE (SIZE (1.. maxNrofUL-Allocations-r16)) OF |

INTEGER (0..128),

| | |
|---|---|
| reportSlotOffsetListDCI-0-1 | SEQUENCE (SIZE (1.. maxNrofUL-Allocations-r16)) OF |

INTEGER (0..128),

| | |
|---|---|
| rach-ConfigDedicated | CHOICE { |
| uplink | RACH-ConfigDedicated, |
| supplementaryUplink | RACH-ConfigDedicated OPTIONAL, -- Need N |

}

| | |
|---|---|
| p0alpha | P0-PUSCH-AlphaSetId |
| cli-EventConfig | CLI-EventConfig |

```
  },
  ...
},
```

According to an embodiment, the Event-based configuration may include a resource in which the UE may transmit CSI when a specific L1 measurement reporting event is satisfied and may include, for example, at least one of the following information:
Periodic resource (e.g., information included in periodic, semiPersistentOnPUCCH, semiPersistentOnPUSCH, and aperiodic); and/or
An RACH resource to notify a base station of Event based UE CSI report (e.g., it may have the form of contention-free RACH or contention-based RACH resource, RACH-ConfigDedicated or RACH-ConfigCommon).

According to an embodiment, furthermore, the configuration for the measurement reporting event in the event-based configuration may include at least one of following information:
A type and condition of event triggering measurement reporting (e.g., an event in which a measured interference signal exceeds a threshold);
A parameter configuration for each event;
1) A time of a measurement window to be used for L1 measurement (e.g., a measurement value acquired after the window time has elapsed may not be used);
2) The number of measurement instances (e.g., if the number of samples measured within a measurement window does not reach a required number of instances, the measurement value may not be used);
3) A threshold, offset, and hysteresis for comparison with a measured signal;
4) A time to trigger measurement reporting (e.g., time to trigger);
5) A configuration for transmitting a measurement report when a measurement condition is no longer satisfied (e.g., reportonleave); and/or
6) A configuration to include an additional indicator in a measurement report when a measurement condition is satisfied for the first time.

According to an embodiment, cli-ReportContent may indicate a content to be included in the CLI measurement report and may include one or more of following information:
nrOfReportedInterference: a maximum number of CLI measurement results which may be included in CSI;
nrOfReportedBeam: a maximum number of beam measurement results which may be included in CSI;
spCellInclusion: whether to include a spell measurement result in CSI; and/or
reportTriggeredBeam: in case of event-based, only a beam having triggered an L1 measurement reporting event is included in CSI.

In step 844, the first base station 801 may transmit an RRC message (e.g., RRCReconfiguration) for configure measurement to the first UE 811.

In step 845, the first base station 801 may transmit a MAC CE or DCI message to the first UE 811 to indicate semi-persistent or aperiodic measurement to the first UE 811.

According to an embodiment, in the case of Semi-persistent measurement, in step 846, the first UE 811 may start measurement at a time point which has been indicated to start the measurement through the MAC CE or DCI message by the first base station 801. The first UE 811 may transmit a measurement report to the first base station 801 on a resource configured to periodically transmit a measurement report through an RRC message.

In step 848, the first base station 801 may transmit a MAC CE or DCI message to the first UE 811 to stop the semi-persistent measurement of the first UE 811. The first UE 811, in case that the MAC CE or DCI message including the indication to stop the semi-persistent measurement, may not perform the measurement and reporting any more.

According to an embodiment, in the case of Aperiodic measurement, in step 846, the first UE 811 may start measurement at a time point which has been indicated to start the measurement through the MAC CE or DCI message by the first base station 801. The first UE 811 may transmit a measurement report to the first base station 801 on a resource configured to transmit a measurement report through an RRC message (or MAC CE or DCI). The first UE 811 that performed the Aperiodic measurement and reporting may not perform measurement and reporting any more.

According to various embodiments, the first UE 811, as indicated by the first base station 801 through the RRC message, may transmit a measurement result through the L1 message (e.g., CSI) to the first base station 801 when the measurement reporting event has been satisfied or through the periodic measurement report. The CSI including the CLI measurement result may include one or more of following information:
A measurement ID: may indicate an identifier of a source configured for measurement and may be identical to cli-CSI-ReportConfigId;
An SRS resource ID: may indicate an identifier of a measured SRS, and may represent a range identical to maxNrofSRS-Resources, for example, using 6 bits;
SRS-RSRP: may indicate RSRP of a measured SRS and may indicate, for example, using 7 bits, a value in a range from −140 dBM to −44 dBM, and may indicate, in units of 1 dBm, even the infinity for which the SRS is not measured because the signal is too strong;
An RSSI resource ID: may indicate an identifier of a measured RSSI, and may represent a range identical to maxNrofCLI-RSSI-Resources, for example, using 6 bits;
A CLI-RSSI: may indicate RSRP of a measured RSSI and may indicate, for example, using 7 bits, a value in a range from −100 dBm to −25 dBm in units of 1 dBm;
Rx beam info: may be represented as TCI-state ID and may be 6 bits for PDCCH and QCL, or 7 bits for PDSCH and QCL, for example;
Tx beam info: is Tx beam information of a spcell, and may be 8 bits, for example;
A Cell Index: may indicate a cell index of a spcell or a scell;
An SSB index: may indicate an SSB index of a measured cell;
An SRS or RSSI indicator: is an identifier indicating whether a measurement result included in CSI is SRS-RSRP or a CSI-RSSI;
SSB-RSRP: may indicate RSRP of a measured SRS and may indicate, for example, using 7 bits, a value in a range from −140 dBM to −44 dBM, and may indicate, in units of 1 dBm, even the infinity for which the SRS is not measured because the signal is too strong;
CSI-RS-RSRP: may indicate RSRP of a measured CSI-RS and may indicate, for example, using 7 bits, a value in a range from −140 dBM to −44 dBM, and may indicate, in units of 1 dBm, even the infinity for which the CSI-RS-RSRP is not measured because the signal is too strong; and/or
An indicator indicating CSI first transmitted after satisfying the measurement reporting event.

According to an embodiment, in step 847, the first UE 811 may transmit, through an MAC CE, information having a level equal to that of the measurement report using CSI. The first base station 801 may transmit an indicator to use MAC CE through RRC, MAC CE, or DCI. According to an embodiment, in the case of indication through the RRC, the first base station 801 may indicate to the first UE 811 through the MAC CE or DCI to begin measuring and reporting the measurement resource configured with the RRC, and the initiated measurement reporting may continue until the first base station 801 stops the measurement by using the MAC CE or DCI, or releases the configuration by using the RRC. The first UE 811 may perform the L1 measurement reporting through the MAC CE by using the MAC CE which may be divided into a logical channel ID (LCID) or e-LCID.

According to an embodiment, in order to release the CLI measurement configuration from the first UE 811, the RRC message transmitted by the first UE 811 may include a configuration (e.g., a list) including at least one CLI measurement configuration identifier to be released, and may be in the form, for example, as follows:
cli-CSI-ReportConfigToReleaseList SEQUENCE (SIZE (1 . . . maxNrofCLI-CSI-ReportConfigurations)) OF CLI-CSI-ReportConfigId.

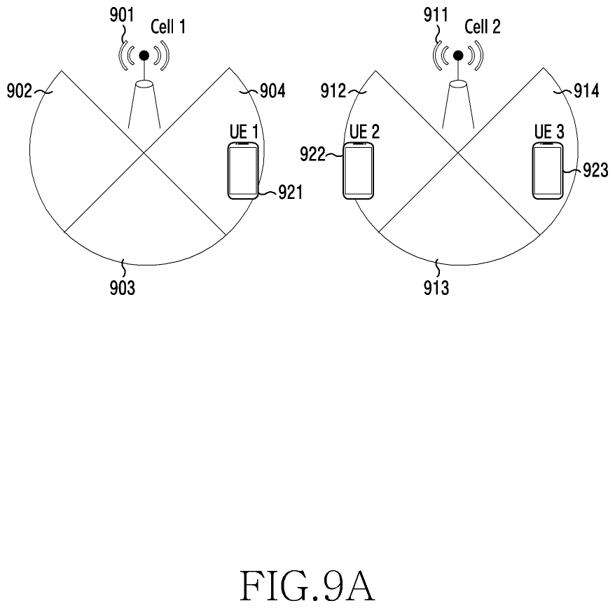

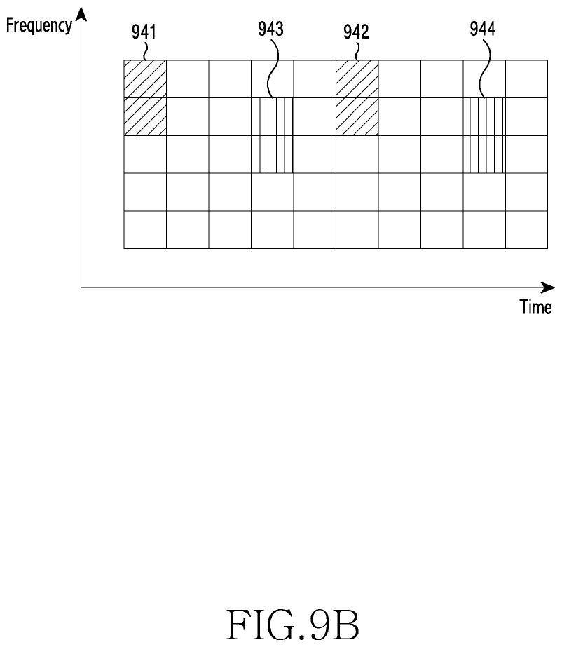

FIGS. 9A and 9B illustrate an example of a relationship between a resource for measuring CLI and a resource used for a downlink (DL) or uplink (UL) according to an embodiment of the disclosure. More specifically, FIGS. 9A and 9B depict the relationship between a resource for a victim UE to measure CLI and a resource available for DL or UL.

Referring to FIG. 9A, a first cell 901 may service a first UE 921, and a second cell 911 may service a second UE 922 and a third UE 923. Each cell 901 or 911 may use at least one beam for efficient use of frequency, the first cell 901 may use three beams 902, 903, and 904, and the second cell 911 may use three beams 912, 913, and 914. Referring to FIG. 9A, it is illustrated that the first UE is positioned to corresponding to a beam 904 of the first cell 901, the second UE is positioned to corresponding to a beam 912 of the second cell 911, and the third UE is positioned to corresponding to a beam 914 of the second cell 911.

According to an embodiment, a DL resource (e.g., DL of a TDD or DL subband of an SBFD) of the first UE 921 may be identical or adjacent to a UL resource (UL of a TDD or UL subband of an SBFD) of the second UE 922. In this case, as shown in FIGS. 4A and 4B, UE-to-UE CLI may be caused.

According to an embodiment, the first cell 901 may measure CLI of the first UE 921. For example, a CU of the first cell 901 may indicate the first UE 921 to measure the SRS-RSRP on the SRS resource transmitted by the second UE 922 to the second cell 911. The CU of the first cell 901 may indicate to the first UE 921 to measure the SRS-RSRP on the SRS resource transmitted by the third UE 923 to the second cell 911. In addition, in case that the DL resource of the first cell 901 is identical or adjacent to the UL resource of the second cell 911, the CU of the first cell 901 may indicate to the first UE 921 to measure the CLI-RSSI on the corresponding resource. For the SRS-RSRP or CLI-RSSI measurement, in case that the first cell 901 and the second cell 911 are cells serviced by the same DU or CU, information about the TDD or SBFD pattern of each cell may be shared in advance, as shown in the examples of FIGS. 5A and 5B. Alternatively, in case that the first cell 901 and the second cell 911 are cells serviced by different CUs, information about the TDD or SBFD pattern of each cell may be shared in advance, as shown in the examples of FIGS. 6A and 6B.

According to an embodiment, FIG. 9B illustrates a measurement resource indicated by a base station to a victim UE (e.g., the first UE 921 in FIG. 9A) without considering a beam. Referring to FIG. 9B, the resource measured by the victim UE may include SRSs or PUCCH/PUSCH resources transmitted by two aggressor UEs (e.g., a first aggressor UE may correspond to the second UE 922 in FIG. 9A and a second aggressor UE may correspond to the third UE 923 in FIG. 9A) and a resource 941 or 942 transmitted by the first aggressor UE and a resource 943 or 944 transmitted by the second aggressor UE are described.

According to an embodiment, in order to accurately measure the CLI corresponding to the indicated resource, it is necessary to measure a signal transmitted by the aggressor UE instead of the reception of a DL signal on the measurement object resource. For example, a serving cell of the victim UE may not transmit DL data on the corresponding resource. Accordingly, with respect to the victim UE, fewer resources may be available for DL reception to measure the CLI. According to various embodiments, the examples in FIGS. 9A and 9B illustrate two aggressor UEs, but in case that CLI measurements are indicated for more aggressor UEs, the victim UEs may not be able to use the measurement object resource for DL reception, and thus have very few DL resources available for the duration of the CLI measurement, which may impact seamless service.

According to an embodiment, the serving cell of the aggressor UE may indicate to the aggressor UEs (e.g., the second UE 922 or the third UE 923) to transmit an SRS for CLI measurement. Here, the resource used for the SRS may not be used as a PUSCH or PUCCH. Accordingly, in case of allocating the UL resource for the CLI measurement to the aggressor UE, the aggressor UE may have fewer UL resources available, which may affect the smooth service.

According to an embodiment, referring to FIG. 9A, the second UE 922 and third UE 923 are serviced by the second cell 911 adjacent to the first UE 921, but may be distinguished as an aggressor UE that affects the CLI of the first UE 921 or a UE that does not affect the CLI, depending on the direction or configuration (e.g., the width, the number of beams, or the like) of the beam. Referring to FIG. 9A as an example, the second UE 922 may be an aggressor UE with respect to the first UE 921, and the third UE 923 may not be an aggressor UE with respect to the first UE 921. The first cell 901 may select the measurement resource by considering the beam when indicating to the first UE 921 the CLI measurement object resource. Referring to FIG. 9B, a signal transmitted on the UL resources 941 or 942 of the first aggressor UE that is measured by the victim UE may be a signal that may cause a high level of CLI to the victim UE, and a signal transmitted on the UL resources 943 or 944 of the second aggressor UE may be a signal that may cause a low level of CLI (e.g., negligible level of CLI) to the victim UE. Therefore, the base station servicing the victim UE may indicate to the victim UE to only measure a signal 941 or 942 that may cause a high level of CLI, thereby minimizing the negative impact on the DL recourse available to the victim UE during a CLI measurement period. In addition, the second cell 911 may consider the beam when allocating the UL resource for the CLI measurement to the second UE 922 or the third UE 923. For example, the base station servicing the aggressor UE may allocate a UL resource only to an aggressor UE that uses the UL resource 941 or 942 that may cause CLI. The second cell 911 may select the aggressor UE transmitting a UL signal, in consideration of the beam, thereby minimizing a negative impact on a UL resource used for a signal required to be transmitted for CLI measurement.

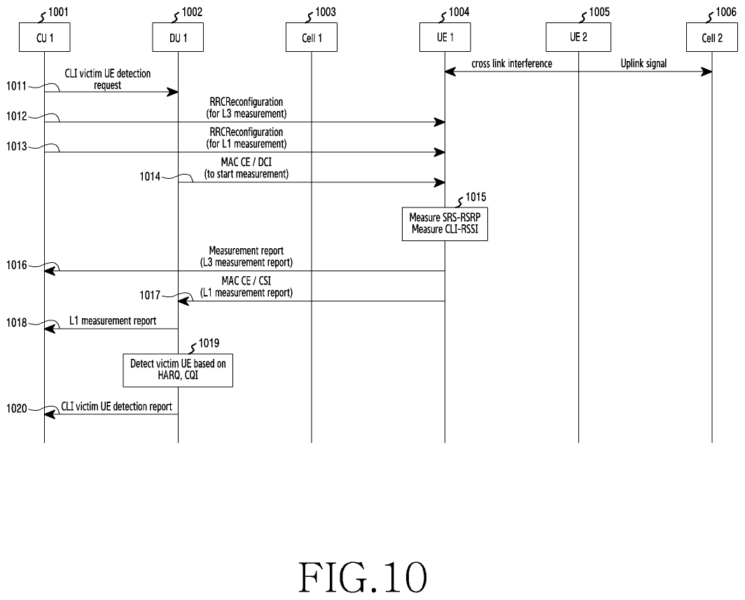

FIG. 10 illustrates a signal flow for predicting a CLI victim UE according to an embodiment of the disclosure.

Referring to FIG. 10, a first CU 1001 may be connected to a first DU 1002 through F1AP, and the first cell 1003 may be connected to the first DU 1002. A first UE 1004 may be connected to the first cell 1003 to proceed with a service. A second UE 1005 may be connected to a second cell 1006 to proceed with a service. The second cell 1006 may be connected to the first CU 1001 through the first DU 1002, or through a DU other than the first DU 1002 not shown in the drawings, and the second cell 1006 may be connected to a CU other than the first CU 1001 through a DU other than the first DU 1002 not shown in the drawings.

According to an embodiment, the first CU 1001 may compare a TDD or SBFD pattern of the first cell 1003 servicing the first UE 1004 with a TDD or SBFD pattern of the second cell 1006 neighboring the first cell 1003. The first CU 1001 may expect that some (e.g., the first UE 1004) of the UEs serviced by the first cell 1003 are victim UEs and some (e.g., the second UE 1005) of the UEs serviced by the second cell 1006 are aggressor UEs. However, in case that the first CU 1001 indicates to all UEs serviced by the first cell 1003 to measure the CLI, only an object UE to measure the CLI may be selected, since a resource used for DL transmission of the serviced UE may be reduced, as shown in the examples in FIGS. 9A and 9B.

For example, the first CU 1001 may use at least one of the following methods to identify a UE that is likely to be a victim UE among multiple UEs serviced thereby.
If the number of consecutive HARQ NACKs for a DL transmission is greater than or equal to a predetermined threshold: It is possible to detect a case where HARQ NACKs by the CLI occur on consecutive resources.
If the number of non-consecutive HARQ NACKs for a predetermined number of DL transmissions is greater than or equal to a predetermined threshold: It is possible to detect a case where HARQ NACKs by the CLI occur on non-consecutive resources.
If a channel quality indicator (CQI) measured by CSI-IM-Resource or a reference signal is less than a predetermined threshold: It is possible to detect reception channel quality degradation due to CLI when the CQI measured by a UE using a reference signal is less than or equal to a threshold.
If a measured SRS-RSRP or CLI-RSSI is greater than or equal to a predetermined threshold, or if a specific condition is satisfied: It is possible to detect CLI based on an RSSI measured by a UE.
A CLI detection indication identifier: an identifier for identifying a threshold or a configuration for measurement.

According to an embodiment, in step 1011, in order to measure CLI caused by the cases described above, the first CU 1001 may transmit an F1AP message (e.g., CLI victim UE detection request) to the first DU 1002 to indicate a threshold. The threshold may include at least one of the number of HARQ NACKs, or the number of DL transmissions, a CQI value, or an RSSI value, and may include an identifier to distinguish a CLI detection indicating operation. According to an embodiment, the first CU 1001 may cause at least one of a public land mobile network (PLMN), a NR cell global identity (NR CGI), or a physical cell identity (PCI) to be included to indicate to the first DU 1002 a cell (e.g., the first cell 1003) in which a victim UE is expected to be present. In addition, the first CU 1001 may cause at least one of a PLMN, a NR CGI, or a PCI to be included to indicate to the first DU 1002 a cell (e.g., the second cell 1006) in which an aggressor UE is expected to be present.

In step 1012, the first CU 1001 may indicate to the first UE 1004, through an RRC message (e.g., RRCReconfiguration), to measure and report SRS-RSRP or CLI-RSSI using the L3 measurement reporting framework for victim UE detection based on the SRS-RSRP or CLI-RSSI. A method by which the first CU 1001 configures the first UE 1004 to measure the SRS-RSRP or CLI-RSSI may be as shown in the example in FIG. 7.

Alternatively, in step 1013, the first CU 1001 may indicate to the first UE 1004, through an RRC message (e.g., RRCReconfiguration), to measure and report SRS-RSRP or CLI-RSSI using the L1 measurement reporting framework for victim UE detection based on the SRS-RSRP or CLI-RSSI.

In step 1014, the first DU 1002 may indicate to the first UE 1004 a semi-permanent or aperiodic measurement through a MAC CE or DCI, as shown in the example in FIG. 8.

In step 1015, the first UE 1004 may proceed with the measurement according to the measurement configuration indicated by the first CU 1001 through the RRC message.

In step 1016, the first UE 1004 may transmit a measurement report to the first CU 1001 through an RRC message (e.g., measurement report) using the L3 measurement reporting framework. Information included in the measurement report may be as shown in the example in FIG. 7.

Alternatively, in step 1015, the first UE 1004 may proceed with the measurement according to the measurement configuration indicated by the first CU 1001 through the RRC message in step 1013. Alternatively, the first DU 1002 may proceed with the measurement according to the measurement indication indicated to the first UE 1004 through the MAC CE or DCI.

In step 1017, the first UE 1004 may transmit a measurement report to the first DU 1002 through the MAC CE or DCI by using the L1 measurement reporting framework. Information included in the measurement report may be as shown in the example in FIG. 8.

In step 1018, the first DU 1002 may transmit the measurement report transmitted by the first UE 1004 through the MAC CE or CSI to the first CU 1001 using the F1AP message. Information included in the F1AP message transmitted by the first DU 1002 to the first CU 1001 may include a portion of the information included in the MAC CE or CSI transmitted by the first UE 1004 to the first DU 1002, and may further include a gNB-CU UE F1AP ID or a gNB-DU UE F1AP ID to identify the first UE 1004.

In step 1019, the first DU 1002 may detect the victim UE based on the information received from the first CU 1001 through the F1AP message in step 1011 and a measurement result (e.g., an L1-based measurement report) or data transmission/reception (e.g., a HARQ-based measurement) with the victim UE (e.g., the first UE 1004).

In step 1020, the first DU 1002 may report information of the victim UE to the first CU 1001 through the F1AP message (e.g., CLI victim UE detection report). The information reported through the F1AP message may include a portion of the following:
A CLI detection indication identifier (an identifier indicated by the CU through the F1AP message ( ));
A gNB-CU UE F1AP ID;
A gNB-DU UE F1AP ID; and/or
A CLI detection result (e.g., the number of consecutive or non-consecutive HARQ NACKs, a CQI value received from the victim UE, or information included in CSI received from the victim UE).

According to various embodiments, the first CU 1001 may identify the victim UE of which CLI is to be measured, based on the information received from the first DU 1002 through the F1AP message in step 1018 or 1020 or the information received from the first UE 1004 through the RRC message (e.g., measurement report).

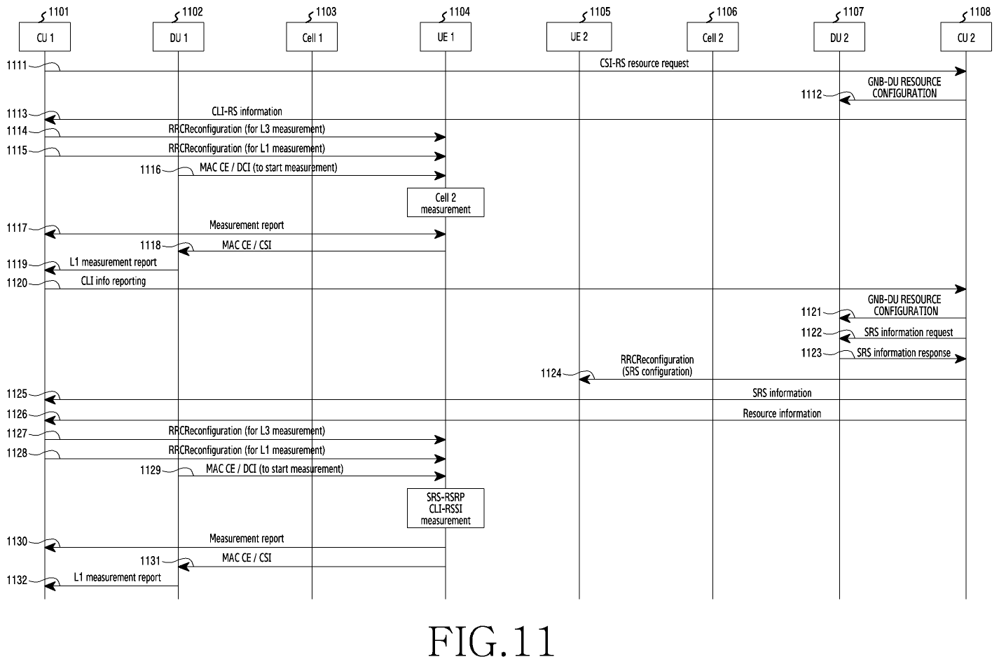

FIG. 11 illustrates a signal flow for selecting a beam-based aggressor UE and measuring CLI according to an embodiment of the disclosure.

Referring to FIG. 11, a first CU 1101 may be connected to a first DU 1102 through F1AP, and the first cell 1103 may be connected to the first DU 1102. A first UE 1104 may be connected to the first cell 1103 to proceed with a service. A second CU 1108 may be connected to a second DU 1107 through F1AP, and a second cell 1106 may be connected to a second DU 1107. A second UE 1105 may be connected to a second cell 1106 to proceed with a service.

According to an embodiment, the second cell 1106 may be connected to the first CU 1101 through the second DU 1107 or another DU other than the first DU 1102 not shown in the drawing. The second cell 1106 may be connected to another CU other than the first CU 1101 through another DU other than the first DU 1102 not shown in the drawing. The drawing illustrates that the first cell 1103 and the second cell 1106 are connected to different CUs to operate.

According to an embodiment, the first CU 1101 may determine the first UE 1104 as a UE to measure CLI and a method for determining same may be as shown in FIG. 10.

According to an embodiment, the first CU 1101 may compare TDD or SBFD patterns of the first cell 1103 and the second cell 1106 or may expect that some (e.g., the second UE 1105) of UEs serviced by the second cell 1106 is an aggressor UE, based on a neighbor cell measurement of the first UE 1104.

According to an embodiment, in case that the second CU 1108 indicates to all UEs serviced by the second cell 1106 to transmit UL signals for CLI measurements, resources used for UL transmission of serviced UEs may be reduced, as shown in the examples of FIGS. 9A and 9B. For example, if UL resources are allocated to transmit UL signals for CLI measurements to multiple UEs serviced by the second cell 1106, the quality of UL service of the UEs serviced by the second cell 1106 may be degraded. To address the issue described above, a method may be needed for the second CU 1108 to identify only a portion of the UEs serviced by the second cell 1106 that transmit UL signals for CLI measurements.

According to an embodiment, the first CU 1101 may indicate to the first UE 1104 to measure a SSB or CSI-RS transmitted by the second cell 1106. In case of indicating the CSI-RS measurement, the first CU 1101 may be required to know CSI-RS resource information transmitted by the second cell 1106.

In step 1111, the first CU 1101 may request the CSI-RS resource information from the second CU 1108 through the XnAP message (e.g., CSI-RS resource request). CSI-RS resource request may include following information:
A CSI-RS resource request information identifier;
NR CGI or PCI of one or more Target cells (e.g., the second cell 1106);
A measurable CSI-RS resource: For example, it may be in the form of a DL symbol in TDD or a DL subband in SBFD. In order for a UE (e.g., the first UE 1104) to measure the CSI-RS of a target cell (e.g., the second cell 1106), the resource to be measured needs to be a resource (e.g., a DL symbol in TDD or a DL subband in SBFD) that the UE may measure; and/or
A beam index requiring transmission of CSI-RS.

In step 1112, in case that the second CU 1108 receives a request for CSI-RS resource information from the first CU 1101 through the XnAP message, the second CU 1108 may configure the CSI-RS resource for the second cell 1106 by transmitting the F1AP message (e.g., GNB-DU RESOURCE CONFIGURATION) to the DU servicing the corresponding cell (e.g., the second DU 1107) to transmit CSI-RS to the requested cell (e.g., the second cell 1106). The CSI-RS resource may include information as shown in [Table 14].

TABLE 14
- NZP-CSI-RS-Resource
The IE NZP-CSI-RS-Resource is used to configure Non-Zero-Power (NZP) CSI-RS transmitted in the
cell where the IE is included, which the UE may be configured to measure on (see TS 38.214 [19],
clause 5.2.2.3.1). A change of configuration between periodic, semi-persistent or aperiodic for an NZP-
CSI-RS-Resource is not supported without a release and add.

NZP-CSI-RS-Resource information element

-- ASN1START
-- TAG-NZP-CSI-RS-RESOURCE-START

| NZP-CSI-RS-Resource ::= | SEQUENCE { | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db−3, db0, db3, db6} | OPTIONAL, -- Need R |
| scramblingID | ScramblingId, | |
| periodicityAndOffset | CSI-ResourcePeriodicityAndOffset | OPTIONAL, -- Cond |

PeriodicOrSemiPersistent

| | | |
|---|---|---|
| qcl-InfoPeriodicCSI-RS | TCI-StateId | OPTIONAL, -- Cond Periodic |

```
  ...,
  [[
```

| | | |
|---|---|---|
| subcarrierSpacing-r18 | SubcarrierSpacing | OPTIONAL, -- Cond LTM |
| absoluteFrequencyPointA-r18 | ARFCN-ValueNR | OPTIONAL, -- Cond LTM |
| cyclicPrefix-r18 | ENUMERATED {extended} | OPTIONAL -- Cond LTM |

]]
}
-- TAG-NZP-CSI-RS-RESOURCE-STOP
-- ASN1STOP

In step 1113, the second CU 1108 may transmit the XnAP message (e.g., CSI-RS information) to the first CU 1101 to inform the first CU 1101 of the CSI-RS resource for the second cell 1106. The XnAP message may include following information:
A CSI-RS resource request information identifier: an identifier included in the XnAP message transmitted by the first CU 1101 to the second CU 1108;
NR CGI or PCI of one or more Target cells (e.g., the second cell 1106); and/or
A CSI-RS resource (e.g., information in [Table 14]) configured in the target cell where CSI-RS is configured.

In step 1114 or 1115, the first CU 1101 may indicate to the first UE 1104, through the RRC message (e.g., RRCReconfiguration), the reporting of beam-based measurements of one or more cells (e.g., the second cell 1106) servicing one or more aggressor UEs (e.g., the second UE 1105) that cause interference to the first UE 1104. The beam-based measurement reporting for the second cell 1106 may use the L3 measurement reporting framework or the L1 measurement reporting framework, as illustrated in the examples in FIGS. 7 and 8, respectively. For beam-based measurement reporting, the first CU 1101 may additionally include a beam measurement indicator (e.g., includeBeamMeasurements) or an SS/PBCH index indicator in the RRC message (e.g., RRCReconfiguration) transmitted to the first UE 1104.

According to an embodiment, in step 1116, the second DU 1107 may transmit a MAC CE or DCI to indicate to the first UE 1104 to start measuring the second cell 1106 in the L1 measurement reporting framework. The first UE 1104 may initiate a measurement with respect to the measurement resource configured through the RRC message to the first UE 1104.

In step 1117 or 1118, The first UE 1104 may transmit a measurement result for the second cell 1106 to the first CU 1101. The first UE 1104 may transmit the measurement result for the second cell 1106 to the first CU 1101 through the RRC message (e.g., measurement report) in case of using the L3 measurement reporting framework, or to the first DU 1102 through the L1 message (e.g., MAC CE or CSI) in case of using the L1 measurement reporting framework. According to an embodiment, the information transmitted in this case may include at least one of RSRP of the SSB or CSI-RS for the second cell 1106, a CSI-RS resource identifier (e.g., nzp-CSI-RS-ResourceId in [Table 14]), or an SS/PBCH index.

In step 1119, the first DU 1102 may transmit a measurement report for the second cell 1106 transmitted by the first UE 1104 through the MAC CE or CSI to the first CU 1101 using the F1AP message (e.g., L1 measurement report). Information included in the F1AP message transmitted by the first DU 1102 to the first CU 1101 may include a portion of the information included in the MAC CE or CSI transmitted by the first UE 1104 to the first DU 1102, and may further include a gNB-CU UE F1AP ID or a gNB-DU UE F1AP ID to identify the first UE 1104.

In step 1120, the first CU 1101 may transmit the SSB or CSI-RS measurement result for one or more cells serviced by the second CU 1108 (e.g., the second cell 1106) measured by the first UE 1104 to the second CU 1108 through the XnAP message (e.g., CLI info reporting). The XnAP message may include following information:
Information (e.g., NR CGI or PCI) of a cell measured by the victim UE;
A signal (e.g., SSB or CSI-RS) measured by the victim UE;
An identifier (e.g., an SSB index or CSI-RS identifier) of a signal measured by the victim UE;
A strength (e.g., RSRP) of a signal per beam measured by the victim UE, which may be a strength of a signal per cell if the strength per beam may not be provided;
An identifier (e.g., Source NG-RAN node UE XnAP ID) of the victim UE;
An indicator indicating whether there is CLI; and/or
An identifier for an XnAP message (e.g., CLI info reporting).

According to an embodiment, the second CU 1108 may receive the information for the second cell 1106 measured by the first UE 1104 from the first CU 1101 through the XnAP message. The second CU 1108 may determine one or more aggressor UEs (e.g., the second UE 1105) among UEs serviced in the second cell 1106 by considering cell information, beam information, a measured signal strength, and the like.

According to an embodiment, the second CU 1108 may indicate to the aggressor UE (e.g., the second UE 1105) to transmit a UL signal (e.g., an SRS) for CLI measurement. To this end, in step 1121, the second CU 1108 may transmit the F1AP message (e.g., GNB-DU RESOURCE CONFIGURATION) to the second DU 1107 and accordingly, may configure an SRS resource for the second UE 1105. The F1AP message may include at least one of an identifier (e.g., a gNB-CU UE F1AP ID or a gNB-DU UE F1AP ID) of the second UE 1105, or one or more SRS resources (e.g., SRS-Resource in [Table 7]).

According to an embodiment, since the second CU 1108 may not know all resource conditions of the second DU 1107 in real time, the SRS resources that the second CU 1108 indicates to be configured may not actually be available to the second DU 1107. Accordingly, a method by which the second DU 1107 configures an SRS resource may be used.

In step 1122, in case that the second DU 1107 configures the SRS resource, the second CU 1108 may request the SRS resource configuration of the second UE 1105 from the second DU 1107 through the F1AP message (e.g., SRS information request). The F1AP message may include information about at least one of an identifier (e.g., a gNB-CU UE F1AP ID or a gNB-DU UE F1AP ID) of the second UE 1105, an identifier of the SRS configuration message, or a resource (e.g., it may be in the form of a DL symbol in TDD or a DL subband in SBFD) requesting the SRS configuration.

In step 1123, the second DU 1107 may respond to the first CU 1108 with the F1AP message (e.g., SRS information response) indicating the SRS resource to be configured to the second UE 1105. The F1AP message may include at least one of an identifier (e.g., a gNB-CU UE F1AP ID or a gNB-DU UE F1AP ID) of the second UE 1105, or one or more SRS resources (e.g., SRS-Resource in [Table 7]).

In step 1124, the second CU 1108 may configure one or more SRS transmission resource by transmitting the RRC message (e.g., RRCReconfiguration) to the second UE 1105. The SRS transmission resource may be a resource transmitted by the second CU 1108 to the second DU 1107 through the F1AP message (e.g., GNB-DU RESOURCE CONFIGURATION), or may include a resource transmitted by the second DU 1107 to the second CU 1108 through the F1AP message (e.g., SRS information response).

In step 1125, the second CU 1108 may transmit the XnAP message (e.g., SRS information) to the first CU 1101 to deliver the SRS resource that the one or more aggressor UEs (e.g., the second UE 1105) are configured to transmit. The XnAP message may include the following information:
One or more aggressor UE identifiers (gNB-CU UE F1AP Ids or gNB-DU UE F1AP IDs);
An SRS resource (e.g., an SRS-resource in [Table 7]) for each aggressor UE;
A serving cell (e.g., an NR CGI or PCI of the second cell 1106) and a serving beam (e.g., a beam index) for each aggressor UE; and/or
An identifier for an XnAP message (e.g., CLI info reporting) which corresponds to a response object.

In step 1126, the second CU 1108 may transmit resource information to the first CU 1101. For example, in case that it is impossible to configure an SRS to the second UE 1105 based on information transmitted by the first CU 1101 through the XnAP message (e.g., CLI info reporting), or to provide CLI-RSSI measurement resource information using PUCCH or PUSCH of the second UE 1105, the second CU 1108 may transmit the XnAP message (e.g., resource information) to the first CU 1101 to deliver the PUSCH Resource that the one or more aggressor UEs (e.g., the second UE 1105) intend to transmit. The XnAP message may include the following information:
One or more aggressor UE identifiers (gNB-CU UE F1AP Ids or gNB-DU UE F1AP IDs);
A PUCCH resource (e.g., it may be a portion of information included in pucch-Config of 3GPP TS 38.331) for each aggressor UE;
A PUSCH resource (e.g., it may be a portion of information included in pusch-Config of 3GPP TS 38.331) for each aggressor UE;
A serving cell (e.g., an NR CGI or PCI of the second cell 1106) and a serving beam (e.g., a beam index) for each aggressor UE; and/or
An identifier for an XnAP message (e.g., CLI info reporting) which corresponds to a response object.

In step 1127 or 1128, the first CU 1101 may indicate to the first UE 1104, through the RRC message (e.g., RRCReconfiguration) using the L3-based measurement reporting framework or the L1-based measurement reporting framework, the configurations for measuring the SRS-RSRP for each SRS resource of the one or more aggressor UEs (e.g., the second UE 1105) received from the second CU 1108 through the XnAP message.

According to an embodiment, the first CU 1101, the first DU 1102, and the first UE 1104 may measure the SRS of the second UE 1105 according to the example of FIG. 7, in the case of using the L3-based measurement reporting framework, or according to the example of FIG. 8, in the case of using the L1-based measurement reporting framework.

According to an embodiment, in step 1127, the first CU 1101 may indicate to the first UE 1104 the configuration to measure the SRS-RSRP or CLI-RSSI of the second UE 1105 using the L3-based measurement reporting framework by transmitting the RRC message (e.g., RRCReconfiguration). Additionally, the first CU 1101 may indicate that a measurement result transmitted by the first UE 1104 includes the SSB or CSI-RS and beam measurement results of the second cell 1106.

In step 1130, The first UE 1104 may measure the resource configured by the first CU 1101 in the RRC message in step 1127. In case that it is configured to perform measurement reporting periodically, or if an event triggering measurement reporting is satisfied based on the measurement result, the first UE 1104 may transmit the measurement result by transmitting the RRC message (e.g., a measurement report) to the first CU 1101.

According to an embodiment, in step 1128, the first CU 1101 may indicate to the first UE 1104 the configuration to measure the SRS-RSRP or CLI-RSSI of the second UE 1105 using the L1-based measurement reporting framework by transmitting the RRC message (e.g., RRCReconfiguration). Additionally, the first CU 1101 may indicate that a measurement result transmitted by the first UE 1104 includes the SSB or CSI-RS and beam measurement results of the second cell 1106.

In step 1129, the second DU 1107 may transmit a MAC CE or DCI to indicate to the first UE 1104 to begin measurement of CLI in the L1 measurement reporting framework, so as to initiate measurement of the measurement resource configured to the first UE 1104 with the RRC message in step 1128.

According to an embodiment, the first UE 1104 may measure the resource configured by the first CU 1101 through the RRC message. In step 1131, in case that it is configured to perform measurement reporting periodically, or if an event triggering measurement reporting is satisfied based on the measurement result, the first UE 1104 may transmit the measurement result by transmitting the MAC CE or CSI to the first DU 1102.

In step 1132, the first DU 1102 may transfer the measurement result received from the first UE 1104 through the MAC CE or CSI to the first CU 1101 through the F1AP message (e.g., L1 measurement report). The F1AP message may include at least one of information transmitting by the first UE 1104 through the MAC CE or CSI, or an identifier (e.g., a gNB-CU UE F1AP ID or a gNB-DU UE F1AP ID) of the first UE 1104.

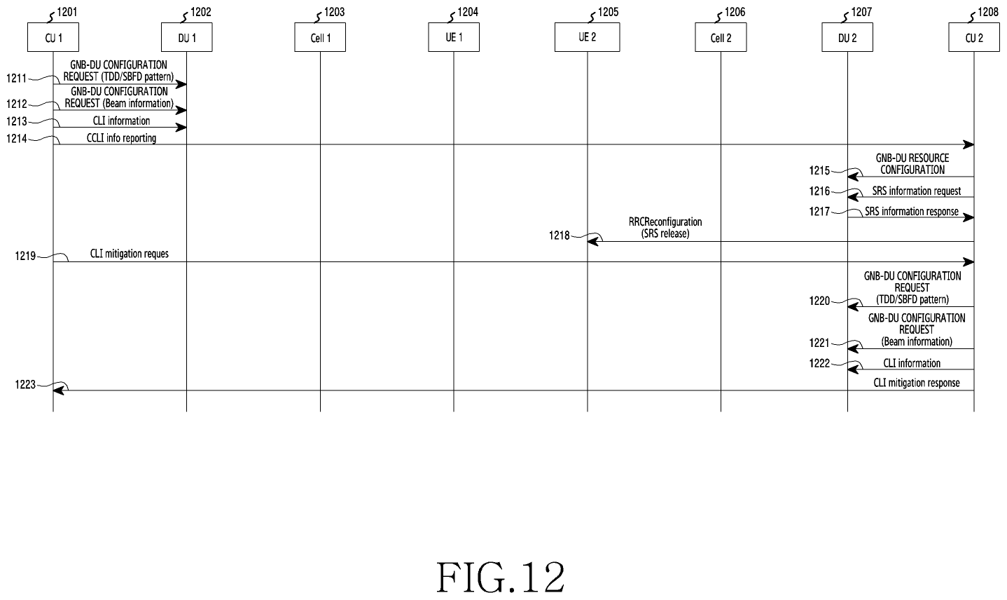

FIG. 12 illustrates a signal flow for mitigating CLI based on CLI measurement reporting according to an embodiment of the disclosure.

Referring to FIG. 12, a first CU 1201 may be connected to a first DU 1202 through F1AP, and the first cell 1203 may be connected to the first DU 1202. A first UE 1204 may be connected to the first cell 1203 to proceed with a service. A second CU 1208 may be connected to a second DU 1207 through F1AP, and a second cell 1206 may be connected to a second DU 1207. A second UE 1205 may be connected to a second cell 1206 to proceed with a service.

According to an embodiment, the second cell 1206 may be connected to the first CU 1201 through the second DU 1207 or another DU other than the first DU 1202 not shown in the drawing. The second cell 1206 may be connected to another CU other than the first CU 1201 through another DU other than the first DU 1202 not shown in the drawing. The drawing illustrates that the first cell 1203 and the second cell 1206 are connected to different CUs to operate.

According to an embodiment, the first CU 1201 may identify that the first UE is the victim UE based on a CLI measurement report (e.g., it may be received through the operation of FIGS. 10 and 11) received from the first UE 1204.

According to an embodiment, the first CU 1201 may determine whether to perform a CLI resolution operation based on the CLI measurement report (e.g., it may be received through the operation of FIGS. 10 and 11) received from the first UE 1204. For example, this may include cases where the value of SRS-RSRP or CLI-RSSI is higher than a pre-configured threshold.

In step 1211, for CLI resolution, the first CU 1201 may indicate information about a change in the TDD or SBFD pattern of the first cell 1203 to the first DU 1202 by transmitting the F1AP message (e.g., GNB-DU CONFIGURATION REQUEST) to the first DU 1202. The F1AP message may include the following information:
An identifier (e.g., NR CGI or PCI) of the first cell 1203;
An identifier (e.g., NR CGI or PCI) of a serving cell (e.g., the second cell 1206) of one or more aggressor UEs;
A new TDD pattern (e.g., the TDD pattern information in FIG. 5) to be used by the first cell 1203; and/or
A new SBFD pattern (e.g., the SBFD pattern information in FIG. 5) to be used by the first cell 1203.

For example, the first DU 1202 may apply the indicated new TDD or SBFD pattern to the first cell 1203.

In step 1212, for CLI resolution, the first CU 1201 may indicate a request to deactivate a beam used by the first cell 1203 by transmitting the F1AP message (e.g., GNB-DU CONFIGURATION REQUEST) to the first DU 1202. The F1AP message may include the following information:
An identifier (e.g., NR CGI or PCI) of the first cell 1203;
An identifier (e.g., NR CGI or PCI) of a serving cell (e.g., the second cell 1206) of one or more aggressor UEs;
A beam index to be deactivated; and/or
A victim UE identifier (a gNB-CU UE F1AP Id or gNB-DU UE F1AP ID).

For example, based on an indicated beam index or a beam where the victim UE exists, the first DU 1202 may indicate deactivation of a specific beam of the first cell 1203.

In step 1213, for CLI resolution, the first CU 1201 may indicate information indicating that CLI exists on the first cell 1203 by transmitting the F1AP message (e.g., CLI information) to the first DU 1202. The F1AP message may include the following information:
An identifier (e.g., NR CGI or PCI) of the first cell 1203;
An identifier (e.g., NR CGI or PCI) of a serving cell (e.g., the second cell 1206) of one or more aggressor UEs;
A victim UE identifier (a gNB-CU UE F1AP Id or gNB-DU UE F1AP ID); and/or
Resource information (e.g., a slot and symbol of TDD, a slot and symbol of SBFD, or a frequency) affected by CLI.

For example, the first DU 1202 may indicate to change the TDD or SBFD pattern of the first cell 1203, based on information that CLI exists on the first cell 1203, received through the F1AP message in step 1213 from the first CU 1201, or may indicate to deactivate a specific beam of the first cell 1203, based on the beam where the victim UE exists. The deactivation of a specific beam may be performed through at least one of a method for deactivating a DL beam, a method for deactivating a UL beam, or a method for adjusting transmission or reception power of a beam to adjust a communication range.

In step 1214, the first CU 1201 may inform the second CU 1208 of the CLI information by transmitting the XnAP message (e.g., CLI info reporting). The XnAP message may include the following information:
Information (e.g., NR CGI or PCI) of a cell measured by the victim UE;
A signal (e.g., SSB or CSI-RS) of a neighboring cell (e.g., the second cell 1206) measured by the victim UE;
An identifier (e.g., an SSB index or CSI-RS identifier) of a signal of a neighboring cell (e.g., the second cell 1206) measured by the victim UE;
A type (e.g., SRS-RSRP or a CLI-RSSI and additionally including an identifier (id) of an SRS or RSSI resource) of signal of a neighboring cell (e.g., the second cell 1206) measured by the victim UE;
A strength (e.g., SRS-RSRP or a CLI-RSSI in dBm) of a signal of a neighboring cell (e.g., the second cell 1206) measured by the victim UE;
A strength (e.g., RSRP) of a signal per beam of a neighboring cell (e.g., the second cell 1206) measured by the victim UE, which may be a strength of a signal per cell if the strength per beam may not be provided;
An identifier (e.g., Source NG-RAN node UE XnAP ID) of the victim UE;
An indicator indicating whether there is CLI;
An identifier for an XnAP message (e.g., CLI info reporting); and/or
A CLI measurement resource release indicator (e.g., it may be an indicator to release a resource for Resource information or the SRS information in FIG. 11 or an indicator to release all CLI measurement resources).

According to an embodiment, the second CU 1208 may identify the CLI information transmitted by the first CU 1201 through the XnAP message and, in case that the CLI measurement resource release is indicated, or the CLI no longer exists, may release the resource for which the CLI measurement resource release is indicated or the SRS resource for all CLI measurements.

In step 1215, the second CU 1208 may transmit the F1AP message (e.g., GNB-DU RESOURCE CONFIGURATION) to the first DU 1202 for SRS resource release to release an SRS resource for the second UE 1205. The F1AP message may include at least one of an identifier (e.g., a gNB-CU UE F1AP ID or a gNB-DU UE F1AP ID) of the second UE 1205, or one or more SRS resource identifiers (e.g., SRS-ResourceId).

In step 1216, in case that the second DU 1207 configures the SRS resource, the second CU 1208 may request the SRS resource configuration of the second UE 1205 from the second DU 1207 through the F1AP message (e.g., SRS information request). The F1AP message may include at least one of an identifier (e.g., a gNB-CU UE F1AP ID or a gNB-DU UE F1AP ID) of the second UE 1205, an identifier of the SRS configuration message, or identifier information of the SRS resource.

In step 1217, the second DU 1207 may respond to the first CU 1208 with the F1AP message (e.g., SRS information response) indicating the SRS resource to be released from the second UE 1205. The F1AP message may include at least one of an identifier (e.g., a gNB-CU UE F1AP ID or a gNB-DU UE F1AP ID) of the second UE 1205, or one or more SRS resource identifiers (e.g., SRS-ResourceId).

In step 1218, the second CU 1208 may indicate to the second UE 1205 to release the SRS resource which is to be released by the second DU 1207 from the second UE 1205, by transmitting the RRC message (e.g., RRCReconfiguration). The RRC message may include one or more SRS resource identifiers (e.g., SRS-ResourceId) for SRS resource release.

In step 1219, the first CU 1201 may, in case that a CLI mitigation operation through a configuration change of the second CU 1208 is required, request the CLI mitigation by transmitting the XnAP message (e.g., CLI mitigation request) to the second CU 1208. The XnAP message may include the following information:
An identifier (e.g., NR CGI or PCI) of the first cell 1203;
An identifier (e.g., NR CGI or PCI) of a serving cell (e.g., the second cell 1206) of one or more aggressor UEs;
Information (e.g., NR CGI or PCI) of a neighboring cell (e.g., the second cell 1206) measured by the victim UE;
A signal (e.g., SSB or CSI-RS) of a neighboring cell (e.g., the second cell 1206) measured by the victim UE;
An identifier (e.g., an SSB index or CSI-RS identifier) of a signal of a neighboring cell (e.g., the second cell 1206) measured by the victim UE;
A type (e.g., SRS-RSRP or a CLI-RSSI and additionally including an identifier (id) of an SRS or RSSI resource) of signal of a neighboring cell (e.g., the second cell 1206) measured by the victim UE;
A strength (e.g., SRS-RSRP or a CLI-RSSI in dBm) of a signal of a neighboring cell (e.g., the second cell 1206) measured by the victim UE;
A strength (e.g., RSRP) of a signal per beam of a neighboring cell (e.g., the second cell 1206) measured by the victim UE, which may be a strength of a signal per cell if the strength per beam may not be provided;
An indicator indicating whether there is CLI; and/or
An identifier for an XnAP message (e.g., CLI mitigation request).

According to an embodiment, the second CU 1208 may perform the CLI mitigation operation for the second DU 1207, based on the information received from the first CU 1201 through the XnAP message (e.g., CLI mitigation request).

In step 1220, 1221, or 1222, the second CU 1208 may transmit the F1AP message (e.g., GNB-DU CONFIGURATION REQUEST, or CLI information) to the second DU 1207. The second CU 1208 may transmit the F1AP message to the second DU 1207 to indicate to the second cell 1206 to apply the new TDD or SBFD pattern or to deactivate a specific beam related to the aggressor UE (e.g., the second UE 1205) of the second cell 1206, or transmit the CLI information for the second cell 1206.

In step 1223, the second CU 1208 may, in case that the CLI mitigation operation is performed with respect to the second DU 1207 or the second cell 1206 based on the XnAP message (e.g., CLI mitigation request) received from the first CU 1201, inform the first CU 1201 of a result thereof through the XnAP message (e.g., CLI mitigation response). The XnAP message may include at least one of the change in the TDD or SBFD pattern of the second cell 1206, the beam deactivation information, or the identifier of the XnAP message. Alternatively, the XnAP message may include information indicating whether the CLI mitigation operation has been performed or the performing is rejected, based on the information about the XnAP message received from the first CU 1201 in step 1219.

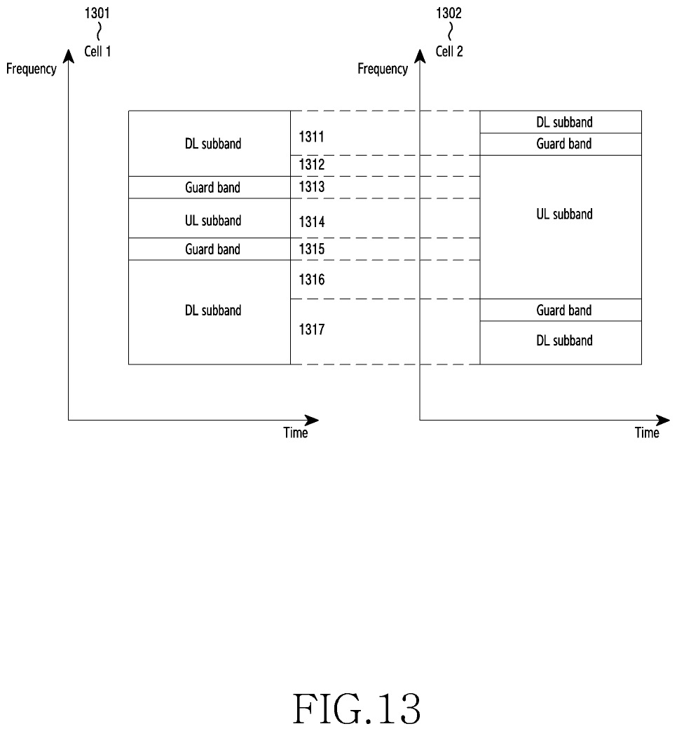

FIG. 13 illustrates a signal flow for dynamically indicating a CLI measurement resource from a base station to a UE according to an embodiment of the disclosure.

FIG. 13 illustrate an SBFD subband configuration of a first cell where a victim UE exists and an SBFD subband configuration of a second cell 1302 where an aggressor UE exists. The first cell 1301 may include more resources of the DL subband to effectively service DL, and the second cell 1302 may include more resources of the UL subband to effectively service UL. The first cell 1301 and the second cell 1302 may be serviced in the same DU or in the same CU but different DUs or in the same CU.

According to an embodiment, a base station of the first cell 1301 may indicate to a victim UE to measure CLI. A method for the base station to indicate to the victim UE to measure CLI may be identical to the methods described with reference to the drawings above. Here, a CLI measurement object source (e.g., an SRS resource or RSSI resource) indicated by the base station to the victim UE serviced in the first cell 1301 may include at least one of a portion or the entirety of a UL subband configured for the second cell 1302.

According to an embodiment, the victim UE serviced in the first cell 1301 may perform CLI measurement within a BWP including a DL subband, a guard band, and a UL subband. Here, in case that the victim UE serviced in the first cell 1301 measures a resource included in the UL subband or the guard band of the first cell 1301, a signal transmitted in the UL subband by any other UE in the first cell 1301 may additionally be measured, and a measurement result may be affected thereby.

In addition, an aggressor UE serviced in the second cell 1302 may transmit a UL signal only in the UL subband. In case that the victim UE serviced in the first cell 1301 measures a resource other than a UL signal resource transmitted by the aggressor UE, a produced CLI measurement result may be different from an intended result.

For example, depending on the use of the UL subband in the first cell 1301 (e.g., a UE other than the victim UE transmits a UL signal in the first cell 1301) and a combination of a resource that the aggressor UE serviced by the second cell 1302 transmits a UL signal and a resource that the victim UE measures, the accuracy of the CLI measurement result measured by the victim UE may vary.

According to various embodiments of the disclosure, referring to FIG. 13, the measurement resource measurable by the victim UE in the first cell 1301 may be divided into multiple sections 1311, 1312, 1313, 1314, 1315, 1316, and 1317 according to a subband configuration of the second cell 1302. In case of division according to the UL transmission section of the aggressor UE, section 1311 may be a section in which the aggressor UE does not transmit a UL signal, sections 1312, 1313, 1314, 1315, and 1316 may be sections in which the aggressor UE transmits a UL signal, and section 1317 may be a section in which the aggressor UE does not transmit a UL signal.

Section 1311 may be a DL subband where the victim UE may not measure the CLI caused by the aggressor UE.

Section 1312 may be a DL subband where the victim UE may measure the CLI caused by the aggressor UE.

Section 1313 may be a guard subband where the victim UE may measure the CLI caused by the aggressor UE. Here, in case that another UE transmit a UL signal in the UL subband of the first cell 1301, the accuracy of a measurement result of the CLI caused by the aggressor UE may be reduced due to intra-cell UE-to-UE CLI may be reduced.

Section 1314 may be a UL subband where the victim UE may measure the CLI caused by the aggressor UE. Here, in case that another UE transmit a UL signal in the UL subband of the first cell 1301, the accuracy of a measurement result of the CLI caused by the aggressor UE may be reduced due to the UL signal.

Section 1315 may be a guard subband where the victim UE may measure the CLI caused by the aggressor UE. Here, in case that another UE transmit a UL signal in the UL subband of the first cell 1301, the accuracy of a measurement result of the CLI caused by the aggressor UE may be reduced due to intra-cell UE-to-UE CLI may be reduced.

Section 1316 may be a DL subband where the victim UE may measure the CLI caused by the aggressor UE.

Section 1317 may be a DL subband where the victim UE may not measure the CLI caused by the aggressor UE.

According to an embodiment, if the DU or base station servicing the first cell 1301 is able to dynamically activate or deactivate the measurement of a guard band section 1313 or 1315 and a UL subband section 1314 depending on whether the UL subband of the first cell 1301 is being used, the CLI measurement accuracy of the victim UE may be improved.

According to various embodiments of the disclosure, the L3 measurement reporting framework and the L1 measurement reporting framework illustrated in FIGS. 7 and 8 may be indicated by the base station transmitting the measurement object resource to the victim UE through the RRC message (e.g., RRCReconfiguration). However, whether to use the UL subband 1314 of the first cell 1301 may be based on scheduling of the DU servicing the first cell 1301. The indication through the RRC message is information transmitted by the CU to the victim UE, thereby causing a disadvantage that the scheduling information of the DU may not be informed to the victim UE in real time. Furthermore, in case that the scheduling information of the first cell 1301 and the second cell 1302 is exchanged with each other, time or frequency resources in which the aggressor UE transmits a UL signal in the UL subband sections 1312, 1313, 1314, 1315, and 1316 of the second cell 1302 may change dynamically. If the aggressor UE transmits a UL signal by using some sections (e.g., 1314, 1315, and 1316) of the UL subband, the victim UE may not need to measure some sections (e.g., 1312 and 1313) of the UL subband where the aggressor UE does not transmit the UL signal.

According to an embodiment, to efficiently indicate the measurement object resources that change based on scheduling, the base station of the first cell 1301 may subdivide the measurement object resources and transmit same to the victim UE. When the base station indicates a measurement indication (e.g., semi-permanent or aperiodic) to the victim UE through MAC CE or DCI, subdivided resource information within the measurement resource may be included and indicated. The victim UE may perform measurements on only the measurement resources indicated by the MAC CE or DCI, not all of the measurement resources, and may perform reporting based on a measurement result.

According to various embodiments, in case of using the L3 measurement reporting framework, the measurement object resource may be included in measObjectCLI as shown in the example in [Table 6]. The measurement object resource may be an SRS resource or an RSSI resource.

According to an embodiment, in case that the SRS resource is subdivided, information indicating each SRS resource may additionally include following information:
An index of the subdivided SRS resource;
A frequency range of the subdivided SRS resource (e.g., it may be represented by a starting point and the number of PRBs, or it may be represented by a frequency (e.g., ARFCN-NR, or resource indicator value (RIV));
A time range (e.g., a starting symbol and the number of symbols) for the subdivided SRS resource; and/or
Configuration information of the granular SRS resource (e.g., it may represent the intersection of a measurement resource with an index of a DL subband of the measurement UE, or it may represent the intersection of a measurement resource with an index of a guard band of the measurement UE, or it may represent the intersection of a measurement resource with an index of a UL subband of the measurement UE, or it may be a combination of one or more configurations of each intersection): Each subdivided resource may be a pre-configured identifier (e.g., an enum), or an index indicating the order of resources (e.g., descending or ascending based on a configured order or frequency), or a bitmap of a resource set.

According to an embodiment, in case that the RSSI resource is subdivided, information indicating each RSSI resource may additionally include following information:
An index of the subdivided RSSI resource;
A frequency range of the subdivided RSSI resource (e.g., it may be represented by a starting point and the number of PRBs, or it may be represented by a frequency (e.g., ARFCN-NR, or resource indicator value (RIV));
A time range (e.g., a starting symbol and the number of symbols) for the subdivided RSSI resource; and/or
Configuration information of the granular RSSI resource (e.g., it may represent the intersection of a measurement resource with an index of a DL subband of the measurement UE, or it may represent the intersection of a measurement resource with an index of a guard band of the measurement UE, or it may represent the intersection of a measurement resource with an index of a UL subband of the measurement UE, or it may be a combination of one or more configurations of each intersection): Each subdivided resource may be a pre-configured identifier (e.g., an enum), or an index indicating the order of resources (e.g., descending or ascending based on a configured order or frequency), or a bitmap of a resource set.

According to various embodiments, in the L3 measurement reporting framework as shown in the example of FIG. 7, the victim UE may measure the resource indicated by the RRC message (e.g., RRCReconfiguration) immediately after the time point at which the RRC message is received. However, in case that the base station indicates the measurement of subdivided measurement object resources, it needs to be indicated through MAC CE or DCI, not through RRC messages. To indicate subdivided measurement resources through MAC CE or DCI, the following information may be included:
A measurement identifier (e.g., measId);
A measurement object identifier (e.g., measObjectId);
A reporting configuration identifier (e.g., reportConfigId);
A measurement object resource identifier (e.g., srs-ResourceId or rssi-ResourceId); and/or
A subdivided resource identifier (e.g., an index of a subdivided SRS/RSSI resource, or a configuration information identifier or index or bitmap of a subdivided SRS/RSSI resource).

According to an embodiment, in case that the subdivided measurement object resources are indicated through the MAC CE or DCI, the victim UE may measure the corresponding resources and may report a measurement result by transmitting the RRC message (e.g., measurement report) to the base station based on the measurement result.

According to various embodiments, in case of using the L1 measurement reporting framework, the measurement object resource such as cli-CSI-ResourceSet in FIG. 8 may be included and configured. The measurement object resource may be an SRS resource or an RSSI resource.

According to an embodiment, in case that the SRS resource is subdivided, information indicating each SRS resource may additionally include following information:
An index of the subdivided SRS resource;
A frequency range of the subdivided SRS resource (e.g., it may be represented by a starting point and the number of PRBs, or it may be represented by a frequency (e.g., ARFCN-NR, or resource indicator value (RIV));
A time range (e.g., a starting symbol and the number of symbols) for the subdivided SRS resource; and/or
Configuration information of the granular SRS resource (e.g., it may represent the intersection of a measurement resource with an index of a DL subband of the measurement UE, or it may represent the intersection of a measurement resource with an index of a guard band of the measurement UE, or it may represent the intersection of a measurement resource with an index of a UL subband of the measurement UE, or it may be a combination of one or more configurations of each intersection): Each subdivided resource may be a pre-configured identifier (e.g., an enum), or an index indicating the order of resources (e.g., descending or ascending based on a configured order or frequency), or a bitmap of a resource set.

According to an embodiment, in case that the RSSI resource is subdivided, information indicating each RSSI resource may additionally include following information:
An index of the subdivided RSSI resource;
A frequency range of the subdivided RSSI resource (e.g., it may be represented by a starting point and the number of PRBs, or it may be represented by a frequency (e.g., ARFCN-NR, or resource indicator value (RIV));
A time range (e.g., a starting symbol and the number of symbols) for the subdivided RSSI resource; and/or
Configuration information of the granular RSSI resource (e.g., it may represent the intersection of a measurement resource with an index of a DL subband of the measurement UE, or it may represent the intersection of a measurement resource with an index of a guard band of the measurement UE, or it may represent the intersection of a measurement resource with an index of a UL subband of the measurement UE, or it may be a combination of one or more configurations of each intersection): Each subdivided resource may be a pre-configured identifier (e.g., an enum), or an index indicating the order of resources (e.g., descending or ascending based on a configured order or frequency), or a bitmap of a resource set.

According to various embodiments, in the L1 measurement reporting framework as shown in the example of FIG. 8, the victim UE may measure the resource indicated by the RRC message (e.g., RRCReconfiguration) immediately after the time point at which the RRC message is received or may start measuring at a time point indicated through the MAC CE or DCI. To indicate subdivided measurement resources through MAC CE or DCI, the following information may be included:
A measurement identifier (e.g., measId);
A measurement object identifier (e.g., measObjectId);
A reporting configuration identifier (e.g., reportConfigId);
A measurement object resource identifier (e.g., srs-ResourceId or rssi-ResourceId); and/or
A subdivided resource identifier (e.g., an index of a subdivided SRS/RSSI resource, or a configuration information identifier or index or bitmap of a subdivided SRS/RSSI resource).

According to an embodiment, in case that the subdivided measurement object resources are indicated through the MAC CE or DCI, the victim UE may measure the corresponding resources and may report a measurement result by transmitting the MAC CE or CSI to the base station based on the measurement result.

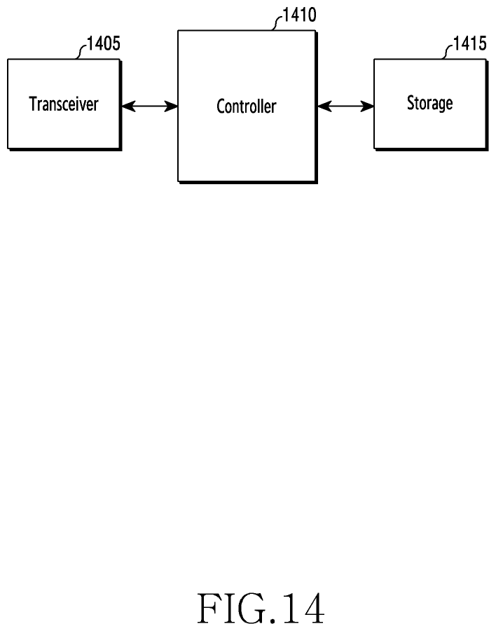

FIG. 14 illustrates a structure of a base station according to an embodiment of the disclosure.

The base station may include a transceiver 1405, a controller 1410, and a storage 1415. The transceiver 1405, the controller 1410, and the storage 1415 may be operated according to the above-described communication methods of the base station. A network device may also correspond to the structure of the base station. However, components of the base station are not limited to the above-described example. For example, the base station may include a larger or smaller number of components than the above-described components. For example, the base station may include the transceiver 1405 and the controller 1410. Furthermore, the transceiver 1405, the controller 1410, and the storage 1415 may be implemented in the form of a single chip.

The transceiver 1405 refers to a base station receiver and a base station transmitter as a whole, and may transmit/receive signals with UEs, other base stations, and other network devices. The transmitted/received signals may include control information and data. The transceiver 1405 may transmit, for example, system information, synchronization signals, or reference signals to UEs. To this end, the transceiver 1405 may include an RF transmitter configured to up-convert and amplify the frequency of transmitted signals, an RF receiver configured to low-noise-amplify received signals and down-convert the frequency thereof, and the like. However, this is only an embodiment of the transceiver 1405, and the components of the transceiver 1405 are not limited to the RF transmitter and the RF receiver. The transceiver 1405 may include wired/wireless transceivers, and may include various components for transmitting/receiving signals. In addition, the transceiver 1405 may receive signals through a communication channel (e.g., a radio channel), output the same to the controller 1410, and transmit signals output from the controller 1410 through the communication channel. Furthermore, the transceiver 1405 may receive communication signals, output same to a processor, and transmit signals output from the processor to UEs, other base stations, or network entities through a wired/wireless network.

The storage 1415 may store programs and data necessary for operations of the base station. In addition, the storage 1415 may store control information or data included in signals acquired by the base station. The storage 1415 may include storage media such as a ROM, a RAM, a hard disk, a CD-ROM, and a DVD, or a combination of storage media. In addition, the storage 1415 may store at least one of information transmitted/received through the transceiver 1405 and information generated through the controller 1410.

As used herein, the controller 1410 may be defined as a circuit, an application specific integrated circuit, or at least one processor. The processor may include a communication processor (CP) which performs control for communication and an application processor (AP) which controls upper layers such as application programs. The controller 1410 may control the overall operation of the base station according to the embodiments provided in the disclosure. For example, the controller 1410 may control signal flows between the respective blocks to perform operations according to the above-described flowcharts.

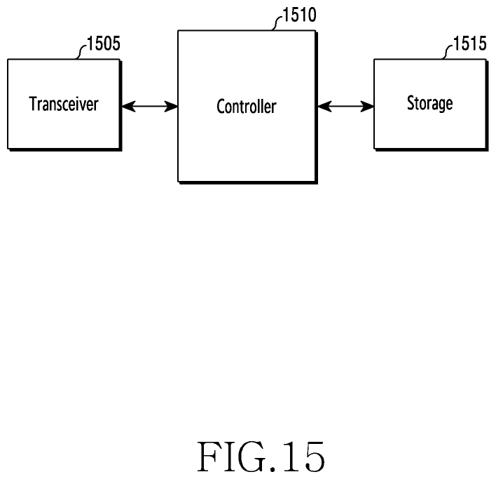

FIG. 15 illustrates a structure of a UE according to an embodiment of the disclosure.

The UE may include a transceiver 1505, a controller 1510, and a storage 1515. The transceiver 1505, the controller 1510, and the storage 1515 may be operated according to the above-described communication methods of the UE. Components of the UE are not limited to the above-described example. For example, the UE may include a larger or smaller number of components than the above-described components. For example, the UE may include the transceiver 1505 and the controller 1510. Furthermore, the transceiver 1505, the controller 1510, and the storage 1515 may be implemented in the form of a single chip.

The transceiver 1505 refers to a UE receiver and a UE transmitter as a whole, and may transmit/receive signals with base stations, other UEs, and network entities. The signals transmitted/received with the base station may include control information and data. The transceiver 1505 may receive, for example, system information, synchronization signals, or reference signals from the base station. To this end, the transceiver 1505 may include an RF transmitter configured to up-convert and amplify the frequency of transmitted signals, an RF receiver configured to low-noise-amplify received signals and down-convert the frequency thereof, and the like. However, this is only an embodiment of the transceiver 1505, and the components of the transceiver 1505 are not limited to the RF transmitter and the RF receiver. Also, the transceiver 1505 may include wired/wireless transceivers, and may include various components for transmitting/receiving signals. In addition, the transceiver 1505 may receive signals through a radio channel, output the same to the controller 1510, and transmit signals output from the controller 1510 through the radio channel. Furthermore, the transceiver 1505 may receive communication signals, output same to a processor, and transmit signals output from the processor to network entities through a wired/wireless network.

The storage 1515 may store programs and data necessary for operations of the UE. In addition, the storage 1515 may store control information or data included in signals acquired by the UE. The storage 1515 may include storage media such as a ROM, a RAM, a hard disk, a CD-ROM, and a DVD, or a combination of storage media.

As used herein, the controller 1510 may be defined as a circuit, an application specific integrated circuit, or at least one processor. The processor may include a communication processor (CP) which performs control for communication and an application processor (AP) which controls upper layers such as application programs. The controller 1510 may control the overall operation of the UE according to the embodiments provided in the disclosure. For example, the controller 1510 may control signal flows between the respective blocks to perform operations according to the above-described flowcharts.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first base station in a wireless communication system, the method comprising:
transmitting, to a second base station, a first Xn message;
receiving, from the second base station, a second Xn message; and
transmitting, to a second base station, a request message for a cross link interference (CLI) mitigation,
wherein the first Xn message includes first served cell information including subband full duplex (SBFD) information for a cell of the first base station, and
wherein the second Xn message includes second served cell information including SBFD information for a cell of the second base station.

2. The method of claim 1, wherein the first Xn message is one of a Xn setup request message or a next generation-radio access network (NG-RAN) node configuration update message, and
wherein the second Xn message is one of a Xn response message or an NG-RAN configuration update acknowledge message.

3. The method of claim 1, further comprising:
transmitting, from a distributed unit (DU) of the first base station to a central unit (CU) of the first base station, a first F1 message; and
transmitting, from the CU of the first base station to the DU of the first base station, a second F1 message,
wherein the first F1 message includes third served cell information including SBFD information for a cell of the DU, and
wherein the second F1 message includes neighbor cell information including the SBFD information for the cell of the second base station.

4. The method of claim 3, wherein the first F1 message is one of a F1 setup request message or a DU configuration update message, and
wherein the second F1 message is a CU configuration update message.

5. The method of claim 1, further comprising:
transmitting, to the second base station, a third Xn message including information on a channel state information-reference signal (CSI-RS) for the cell of the first base station.

6. The method of claim 1, further comprising:
transmitting, to a user equipment (UE), first information configuring a resource for a CLI measurement;
transmitting, to the UE, second information configuring a transmission configuration indicator (TCI) state corresponding to the resource for the CLI measurement; and
receiving, from the UE, an aperiodic report for the CLI measurement based on the TCI state.

7. The method of claim 6, wherein the resource for the CLI measurement is one of a sounding reference signal (SRS) resource or a received signal strength indicator (RSSI) resource.

8. A first base station in a wireless communication system, the first base station comprising:
at least one transceiver;
at least one processor communicatively coupled to the at least one transceiver; and
at least one memory, communicatively coupled to the at least one processor, storing instructions executable by the at least one processor individually or in any combination to cause the first base station to:
transmit, to a second base station, a first Xn message,
receive, from the second base station, a second Xn message, and
transmit, to a second base station, a request message for a cross link interference (CLI) mitigation,
wherein the first Xn message includes first served cell information including subband full duplex (SBFD) information for a cell of the first base station, and
wherein the second Xn message includes second served cell information including SBFD information for a cell of the second base station.

9. The first base station of claim 8, wherein the first Xn message is one of a Xn setup request message or a next generation-radio access network (NG-RAN) node configuration update message, and
wherein the second Xn message is one of a Xn response message or an NG-RAN configuration update acknowledge message.

10. The first base station of claim 8, wherein the instructions further cause the first base station to:
transmit, from a distributed unit (DU) of the first base station to a central unit (CU) of the first base station, a first F1 message, and
transmit, from the CU of the first base station to the DU of the first base station, a second F1 message,
wherein the first F1 message includes third served cell information including SBFD information for a cell of the DU, and
wherein the second F1 message includes neighbor cell information including the SBFD information for the cell of the second base station.

11. The first base station of claim 10, wherein the first F1 message is one of a F1 setup request message or a DU configuration update message, and
wherein the second F1 message is a CU configuration update message.

12. The first base station of claim 8, wherein the instructions further cause the first base station to:
transmit, to the second base station, a third Xn message including information on a channel state information-reference signal (CSI-RS) for the cell of the first base station.

13. The first base station of claim 8, wherein the instructions further cause the first base station to:
transmit, to a user equipment (UE), first information configuring a resource for a CLI measurement,
transmit, to the UE, second information configuring a transmission configuration indicator (TCI) state corresponding to the resource for the CLI measurement, and
receive, from the UE, an aperiodic report for the CLI measurement based on the TCI state.

14. The first base station of claim 13, wherein the resource for the CLI measurement is one of a sounding reference signal (SRS) resource or a received signal strength indicator (RSSI) resource.

15. One or more non-transitory computer-readable storage media storing computer-executable instructions that, when executed by at least one processor of a first base station individually or collectively, cause the first base station to perform operations, the operations comprising:
transmitting, to a second base station, a first Xn message;
receiving, from the second base station, a second Xn message; and
transmitting, to a second base station, a request message for a cross link interference (CLI) mitigation,
wherein the first Xn message includes first served cell information including subband full duplex (SBFD) information for a cell of the first base station, and
wherein the second Xn message includes second served cell information including SBFD information for a cell of the second base station.
